(19) United States
(12) Patent Application Publication
(10) Pub. No.: US 2014/0222616 A1
(43) Pub. Date: Aug. 7, 2014

(54) System and Methods for Party Authentication and Credit Assessment in Electronic Purchasing

(71) Applicant: Klarna AB, Stockholm, SE (US)

(72) Inventors: Sebastian SIEMIATKOWSKI, Stockholm (SE); Niklas Adalberth, Stockholm (SE); Victor Jacobsson, Stockholm (SE); David Fock, Stockholm (SE); Henrik Pettersson, Stockholm (SE)

(73) Assignee: Klarna AB, Stockholm (SE)

(21) Appl. No.: 14/071,567

(22) Filed: Nov. 4, 2013

Related U.S. Application Data
(63) Continuation of application No. PCT/EP13/54529, filed on Mar. 6, 2013.
(60) Provisional application No. 61/607,182, filed on Mar. 6, 2012.

(51) Int. Cl. G06Q 20/40; G06Q 20/24; G06Q 30/06

(52) U.S. Cl. CPC G06Q 20/4016; G06Q 30/0633; G06Q 20/24; G06Q 40/025
USPC 705/26.8

(57) ABSTRACT

In certain embodiments, systems and methods may authorize an online transaction over a data communications network, including receiving a request for a transaction from a user via the network where the transaction request relates to a purchase order. Some embodiments include receiving a user identifier, determining if the user identifier provides sufficient information about an identity of said user to fulfill the transaction, requesting additional user identifiers until it is determined that there is sufficient information to fulfill the transaction, and authorizing the transaction if there is sufficient information for transaction fulfillment.

### CROSS-REFERENCE TO RELATED APPLICATIONS

This patent application claims priority from and is related to International application no. PCT/EP13/54529 filed on Mar. 6, 2013, which itself claims priority from U.S. provisional application U.S. 61/607,182 filed on Mar. 6, 2012, which is hereby incorporated by reference in its entirety.

### FIELD OF THE INVENTION

This document describes technologies relating to data processing systems or methods specially adapted for administrative, commercial, or financial purposes and, more particularly, to payment systems that include procedures for supporting electronic purchasing comprising verification and authentication of the parties involved, and credit handling.

More specifically, this document relates to technical solutions and technical bases for implementing such procedures in a computerized environment.

### BACKGROUND

As computers and computer networks have become part of our everyday lives, numerous parties, including merchants, banks, and retail customers are conducting retail transactions over computer networks. Various technologies and protocols have been developed to handle these transactions. Many include mechanisms and procedures to handle payments made from one party to another. Such systems usually implement some sort of verification and authentication procedures for the parties involved.

An example of such a system 102 is shown in FIG. 1. In this Figure an online shopper (not shown) selects goods (step 104) from a displayed goods list at 106, typically an online merchant's website. After selecting goods to purchase, the customer either signs into the system or creates an account (step 110). Next, the customer confirms a number of choices including the goods to purchase (step 114), the shipping address (step 116), and the payment method to use (step 118). The system then verifies certain details with third-party outside sources (step 122). If the payment details (step 120) are confirmed and verified, the purchase is approved (step 124) and allowed to proceed, if not, the purchase is declined (step 126).

One negative characteristic of this prior art system is that the purchase is not confirmed until funds used for purchase are confirmed/secured. This makes the transaction more difficult to complete, and, accordingly, such technical impediments cause fewer transactions.

### SUMMARY

The present invention provides technical solutions in the form of a system, a method and a computer program product for facilitating transactions in electronic purchasing.

In this document the terms user device or customer access device 208 are being used interchangeably.

Systems and methods are disclosed, in accordance with one or more embodiments, which are directed to facilitating a transaction, by way of communications over at least one communications network (210), between a remote user (204) using a user device (208), and a merchant system (206), the system (202) including at least one server (214) in communication with at least the user device (208) and the merchant system (206), the system comprising:
a. display means for presenting a user interface to the user (204) on a display of the user device (208);
b. display means for presenting the user (204) with the option (613, 660) of logging-in to a third party social media service;
c. verification means for, after the user (204) has logged-in to the third party social media service, establishing a communication with the third party social media service to verify the user (204) through an account with the social media service for the user (204);
d. confirmation means for allowing the user (204) to review and confirm a transaction; and
e. means for notifying the merchant system (206) to complete the transaction.

In one or more embodiments a system is provided, wherein the display means presents the user (204) with the option (613, 660) of logging-in to a third party social media service in response to the user (204) selecting the expedited payment option.

In one or more embodiments a system is provided, further comprising means for determining whether the user (204) has authorized the verification of the user (204) through the social media services.

In one or more embodiments a system is provided, wherein the means for determining whether the user (204) has authorized the verification is via an app provided by the system (202).

In one or more embodiments a system is provided, wherein the system further comprises, user interface means allowing the user (204) to select an expedited payment option presented on the display of the user device (208).

In one or more embodiments a system is provided, further comprising means for allowing the user (204) one of a plurality of alternative means for paying for the transaction.

In one or more embodiments a system is provided, further comprising means for requiring the user (204) to provide additional information and for verifying the user (204) against further third party systems (346).

Systems and methods are disclosed, in accordance with one or more embodiments, which are directed to facilitating a transaction, by way of communications over at least one communications network (210), between a remote user (204) using a user device (208) configured to receive input from a user (204), and a merchant system (206), the system and method comprising:
a. at least one server (214) in communication with at least the user device (208) and the merchant system (206), the server (214) being configured to communicate on the communications network (210);
b. means for receiving at least one user purchase order initiated by the user (204) over the network (210), the purchase order including at least an order price;
c. means for receiving at least one item of user identification information;
d. means for communicating with at least one data storage (354);
e. means for retrieving user data (356) for the unique user identifier (204) from the at least one data storage (354) using at least the received item of user identification information;
f. means for determining (362) a unique user identifier (204) using the retrieved user data;
g. means for determining whether sufficient information exists to fulfill the transaction;
h. means for making a credit determination for the user (204) based on the user data and order price;
i. means for fraud detection to reduce the likelihood that the transaction is fraudulent; and
j. means for completing the transaction.

Systems and methods are disclosed, in accordance with one or more embodiments comprising a selection of or a selected combination of the following:
Wherein sufficient information to fulfill the transaction includes at least information for a physical shipping address if the user purchase order is for a physical good.
Wherein sufficient information to fulfill the transaction includes at least user device information if the user purchase order can be fulfilled by means of a download.
Wherein the credit determination includes at least a determination of a maximum credit limit based on the unique user identifier (204).
Wherein the at least one item of user information is at least one of a zip code, an email address, a physical street address, a mobile phone number, and a land line phone number.
Wherein the fraud detection includes at least a determination of the user identity based on at least one of, the order price, the user identification information, the user data, and the credit determination.
Wherein, if the user identity cannot be determined, the server further is configured to request additional user identification information.
Further comprising means for requesting additional user identification information, if a unique user identifier (204) cannot be found, until a unique user identifier (204) can be found.
Wherein the server (214) is further configured to create a reservation for credit when the credit determination is made.
Wherein the server (214) is further configured to receive payment for the at least one user (204) via at least one of an electronic funds transfer, cash, check, credit card, debit card and bank deposit.
Wherein the data storage (354) is at least one of a database and a distributed database.
Wherein the server (214) is further configured to complete the transaction before the user (204) has selected a payment type.
Wherein the stored user information is provided by a third-party.
Wherein the credit determination is based on at least one of, transaction specifics, goods purchased, user details, merchant, the order price, payment plan, user income, payment remarks, user payment history, and recent user purchase activity.

Systems and methods are disclosed, in accordance with one or more embodiments, which are directed to computer-networked transactions, comprising,

at least one server (214) configured to,
receive a transaction request from a user equipment (208) via a computer network (210) including an order price;
receive at least one item of user identification information;
communicate with a data storage (354) containing user identification information and user data;
match the stored user identification information with a unique user identifier (204) via the data storage (354);
retrieve user data from the data storage (354) for the matched unique user identifier (204);
determine if the user data contains sufficient information about the unique user identifier (204) to fulfill the transaction;
make a credit determination for the unique user identifier (204) based on at least one of the user identification information, the order price, and the user data;
make a fraud determination for the unique user identifier (204), based on at least one of the user identification information, the user data, the order price and the credit determination; and
complete the transaction before receiving user payment information.

Systems and methods are disclosed, in accordance with one or more embodiments comprising a selection of or a selected combination of the following:

Wherein the server (214) is further configured to,
request additional user identification information;
receive the additional user information; and

repeat the request for additional user identification information until the server (214) determines at least one of,
there is sufficient information to complete the transaction,
there is sufficient information to complete the credit determination,
there is sufficient information to match the user identification information with a unique user identifier, and
   there is sufficient information to make the fraud determination.
Wherein the user identification information includes at least one of an email address, a zip code, a physical mailing street address, and a phone number.
Wherein the server (214) is further configured to receive the user identification information from a third-party.
Wherein the sufficient information about the unique user identifier (204) to fulfill the transaction includes at least one of, a physical shipping address, an email address of the user and a user equipment (208) information.
Wherein the user identification information, received from the third-party, has already been validated by the third-party.

Systems and methods are disclosed, in accordance with one or more embodiments, which are directed to online transaction, comprising:

a server (214), configured to,
communicate with a data storage (354) and a network (210);
receive a request to initiate the transaction from a user (204) via the network (210) including at least an order price;
receive at least one user identifier information;
retrieve, from the data storage (354), user data, using the received user identifier information;
identify a unique user identifier (204) from the user data;
determine if sufficient user data exists to fulfill the transaction;
determine credit based on at least user data of the unique user identifier (204);
make a fraud determination;
authorize the online transaction before request of payment.

Systems and methods are disclosed, in accordance with one or more embodiments comprising a selection of or a selected combination of the following:
Wherein the data storage (354) is an internal user database.
Wherein user identifier information is received from at least one of a user (204) and a third party (346).
Wherein the server (214) is further configured to, request at least one additional user identifier information if a unique user identifier (204) cannot be determined.
Wherein the determination of whether sufficient user data exists to complete the transaction is based on whether the user data includes at least one of a physical mailing address, an email address of the user and a user equipment (208) information.
Wherein the server (214) is further configured to, request at least one additional user identifier information if sufficient information does not exist to fulfill the transaction.
Wherein the credit determination is made including information from a third party (346).
Wherein the fraud determination is based on at least one of the user identifier information, the user data, the order price, and the credit determination.
Wherein the server is further configured to, request additional user identifier information if there is not sufficient information to make a fraud determination

### BRIEF DESCRIPTION OF THE DRAWINGS

The technology, innovations and related concepts for this system are illustrated in greater detail below with reference to the attached drawings, which should be seen as illustrative and not limiting the scope of this patent document. In the drawings like reference numbers refer to corresponding parts throughout the figures.

FIG. 1 is a schematic flowchart illustrating a typical transaction flow in prior system.

FIG. 2 is a schematic overview example of a system for implementing some example innovations described in this document.

FIG. 3(a) is a schematic flowchart illustrating the process flow during the use of the system illustrated in FIG. 2, according to some embodiments.

FIG. 3(b) is a schematic flowchart, similar to the one in FIG. 3(a) illustrating the process flow during the use of the system illustrated in FIG. 2, according to some embodiments.

FIGS. 4A to 4H are screen shots illustrating what a customer sees and experiences during the process described in FIGS. 3(a) and (b), according to some embodiments.

FIGS. 5A to 5D are screen shots illustrating what the system displays to a customer when a positive customer identification cannot be made, according to some embodiments.

FIGS. 6A to 6D are screen shots illustrating the customer sees and experiences as a result of an integration between the system and a third party when using a social media platform for authentication, according to some embodiments.

FIGS. 7A to 7F are screen shots illustrating the customer experiences for still another version of the process described in FIGS. 3(a) and (b), according to some embodiments.

FIGS. 8A and 8B are screen shots illustrating the customer experiences for a further version of the process described in FIGS. 3(a) and (b), according to some embodiments.

FIGS. 9A to 9B illustrates schematically the process of embodiments handling payment for goods purchased from different merchants.

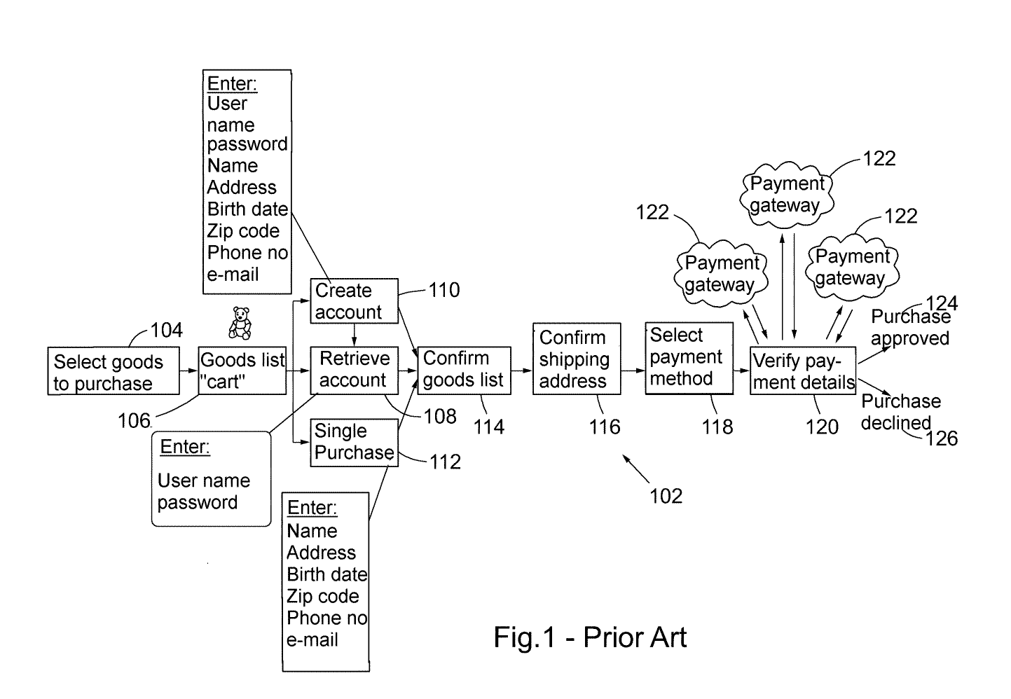

### DETAILED DESCRIPTION

It is to be understood that the Figures illustrating descriptions of and illustrating the present technology have been simplified to illustrate elements that are relevant to understand the technology, while eliminating, for the purpose of clarity, many other elements found in communication systems and methods. Those of ordinary skill in the art may recognize that other elements and/or steps are desirable and/or required in implementing the present technology. This disclosure is however, directed to all such variations and modifications to such elements and methods known to those skilled in the art.

### System Overview

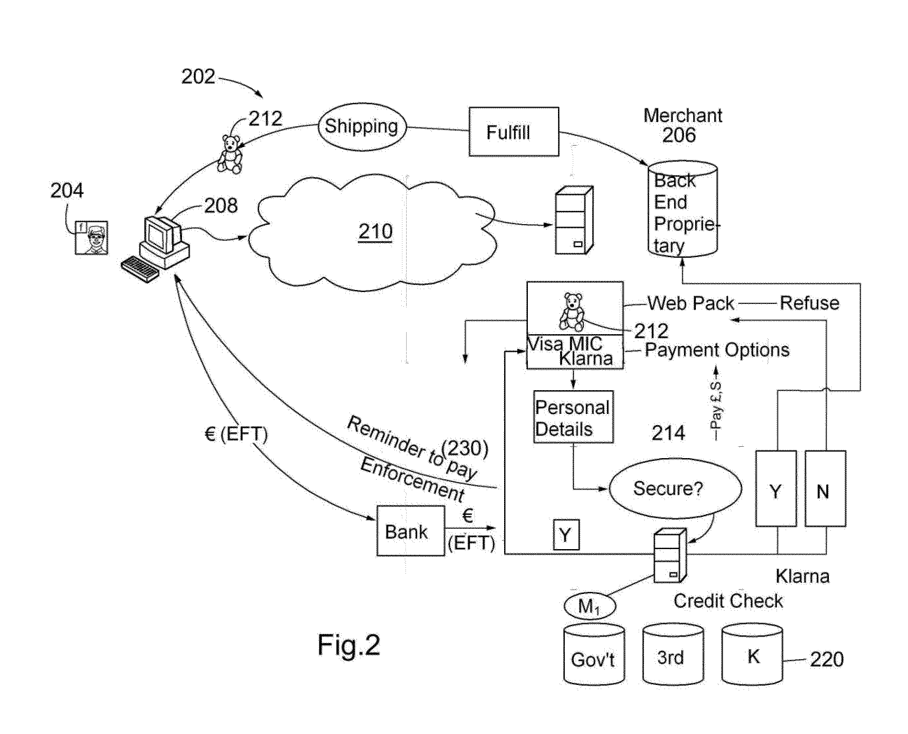

FIG. 2 provides an overview of the main components of the system 202 for implementing some embodiments described in this document. In one embodiment a computer-based system (202) for facilitating a transaction, by way of communications over at least one communications network (210), between a remote user (204) using a user device (208), and a merchant system (206), the system (202) including at least one server (214) in communication with at least the user device (208) and the merchant system (206), the system comprising:
display means for presenting a user interface to the user (204) on a display of the user device (208);
display means for presenting the user (204) with the option (613, 660) of logging-in to a third party social media service;
verification means for, after the user (204) has logged-in to the third party social media service, establishing a communication with the third party social media service to verify the user (204) through an account with the social media service for the user (204);
confirmation means for allowing the user (204) to review and confirm a transaction; and
means for notifying the merchant system (206) to complete the transaction.

As can be seen, the system 202 includes a customer 204 who accesses the website, hosted on the merchant server system 206, using an user access device display means and confirmation means such as a computer 208 executing a web browser. Connection between the customer 204, the merchant's website 206, Online Service server System 214 and an external source 310, like a third-party social network site, is over a network, typically a TCP/IP-based wide area network such as the internet 210 as shown. Connection can also be made over other networks such as POTS telephone or mobile phone networks.

The access device 208 of the customer and the merchant's website are provided with computer software comprising computer program code portions adapted to handle communication of control data through one or more predefined data structures. The merchant's website 206 is for example realized as a merchant server system 206 comprising a server, a merchant database (e.g. backend proprietary in FIG. 2) and software implemented purchase handling functions.

As shown, when the customer wishes to purchase an item 212, the merchant website can 206 contact an Online Service System 214 through an API call, or the Online Service System's user-interface to the internet. The Online Service System 214—sometimes with only a small amount of data—identifies the customer 204 (whether a new or a returning customer as described in detail below), makes a credit assessment and, in certain cases, sets a maximum credit amount, determines whether the credit amount has been exceeded and checks for fraud, etc. Even with this small amount of data, therefore, the technologies deployed allow the system 214 to cause the transaction to occur.

The Online Service System 214 is for example realized as a purchase supporting handling server provided with computer software comprising computer program code portions adapted to realize a selection of: one or more customer identification functions configured to obtain identity information relating to a customer, one or more customer verification functions configured to verify the determined identity of a customer at least to a certain degree of certainty, one or more information completion functions configured to obtain completing information, one or more credit assessment or credit determination functions configured to establish a credit line for a customer in relation to a specific purchase, and/or a payment handling function configured to handle payment for a purchase from a customer and to a merchant. The Online Service System 214 is also provided with communication channels adapted for communicating not only with the merchant website/merchant server system 206 but also with optional external resources like governmental databases, 3^{rd} party service systems or financial organizations 220, with a user device or customer access device 208. For example, after a customer 304 has indicated a list of goods items on the access device 208, indicated the intention to proceed with a purchase of the list of goods items on the access device 208, wherein the access device has an established session to the merchant server system 206, the merchant server system 206 sends a purchase order request including control data, such as a session identifier indicating the access device 208, to the Online Service System 214. A customer control data collecting function comprised in or coupled to the Online Service System 214 requests the customer 304 to input, into an input interface running on or presented on the customer access device 308, one or more items of customer control data and/or customer related data and to transfer them to the data collecting function. The control data items are then for example used in the Online Service System 214 to trigger selected credit assessment function call or other calls to trigger selected functions in the Online Service System 214 dependent on said control data and on one or more sets of predetermined rules. Such credit assessment fiction calls may comprise and pass on also selected parts of the customer control data or other customer related data. In one example the control data function is located in merchant server system 206 and the control data is forwarded to the Online Service System 214. The merchant's website is generally an interface to different server functions on the merchant side.

As described later, the system attempts to complete the purchase even before the customer chooses what payment method to use. This is achieved by creating a “reservation for credit” and extending credit to the customer. This “reservation” can be similar to the reservation made by a credit card company when a request for credit authorization is received at the credit card company. Basically, the system determines, for each known customer, a credit limit up to which the system 214 will honor payments to merchants. The system 214 determines this credit limit based on the customer details in combination with a certain transaction specifics, the goods being purchased, the merchant, the amount, the payment plan, the customer's known income, payment remarks, the customer's payment history, as well as the customer's recent purchasing activity, for example. In some cases, however, it is quite possible that the credit limit can be zero. Optionally, this credit limit is calculated at every transaction and, therefore, does not exist as a specified amount in between transactions. Thus, when the customer selects to be billed, the system calculates the credit line and, if sufficient credit exists, the “reservation for credit is made.” This means that the amount of the purchase is “reserved” against the credit line, effectively reducing the amount of available credit for any subsequent purchase. Unlike a credit card company, however, the fact that a credit line exists and the amount of the credit line is not necessarily made apparent to the customer.

In one or more embodiments, for each customer there is provided in the Online-Service-System 214 a data structure for example in the form of a data record devised for storing customer specific data, e.g. customer control data. The customer specific data record comprises allocations for a selection of data items representing different customer details, such as exemplified above e.g. customer identification data, a credit limit. The credit limit is preferably dynamically calculated for each transaction and set to transaction specific value. Similarly, there is provided in the Online-Service-System 214 a data structure e.g. in the form of a data record devised for storing transaction specifics. The transaction specific data record comprises allocations for a selection of data items representing different transaction detail, such as exemplified above, i.e. the goods items being purchased, the merchant, the amount of the purchase etc.

To initiate the buying of a piece or item of goods, the customer generates control data for triggering a purchase, for example by generating a purchase control data item representing a purchase and sending it to the merchant server system via the merchant's website. The purchase control data then in combination with other customer control data triggers functions to enable carrying out a purchase and initiate shipping of the purchased item more dynamically dependent on the customer's current, possibly estimated, ability to pay for the goods. In one example the customer 304 can complete the purchase and later in time select a preferred method of settlement/payment. The purchased items handled by the inventive system can be of different kinds and be shipped by different shipping methods, such as physical items e.g. clothes, shoes, electronic equipment delivered e.g. by post or courier; electronically carried items e.g. digital media, ebooks, music, film, or services e.g. pay-per-view video delivered e.g. by data communications carriers e.g. via email or streaming; telephone subscription features e.g. mobile phone services, public transport tickets delivered by activating such features on an subscription account; or physically performed services e.g. cleaning or gardening delivered by physical people.

Preferably, selected functions of the Online Service System 214 and/or selected functions of the merchant server system 206 are adapted to complete a purchase separate from the payment procedure and independent from a payment method selected by the customer. In one or more embodiments, for this purpose, the purchase handler function of the Online Service System 214 activates a credit assessment function of the Online Service System 214, e.g. through a function call. In one or more embodiments, for this purpose, the purchase handler of the merchant server system 206 communicates customer control data and a credit assessment request to a credit assessment function of the Online Service System 214. The credit assessment function sets a value, e.g. corresponding to or dependent on the price of the selected goods, to a reservation for credit parameter assigned to the current customer and possibly to the current purchase dependent on a set of predetermined rules. E.g. these predetermined rules would comprise an assessed current credit line for the customer exceeding the price of the piece of goods selected for purchase. In one embodiments, a purchase release parameter is set and communicated to the merchant server system 206 e.g. in response to the value of the reservation for credit parameter being successfully set, whereupon the purchase is controlled to be completed by the merchant server system. Similarly, in one embodiment a purchase block parameter is set and communicated to the merchant server system in the case that a value for the reservation for credit parameter cannot be successfully set. Alternatively or as a complement, a purchase block parameter may e.g. also be set in the merchant server system 206 dependent on a time out function running out.

The completion of the purchase involves the merchant server system initiating shipping of the purchased goods as well as preferably communicating a confirmation of completed purchase parameter being communicated to the Online Service System 214 and typically shipping of the purchased piece of goods is initiated. In response to the confirmation of completed purchase parameter being received by the Online Service System 214, the latter carries out a payment process for example comprising obtaining payment from the customer via a selected transaction process as well as triggering payment to the merchant for example via a transaction from the Online Service System 214 to the merchant server system 206 or via other fund transfer system associated with the merchant.

On shipping, and thus triggered by a received completed purchase parameter from the merchant server system 206, the Online Service System 214 causes a payment to be made to the merchant, for instance, after a predefined e.g. fixed or a computed delay, fourteen days for example. So for example at, or before the invoice's payment due date, the customer 204 pays the invoice using bank or other financial organization 220, to effect an electronic funds transfer (EFT) to the Online Service System 214. Alternatively, as will be described below, the customer can be given other means of making the payment.

If, however, the customer 204 does not pay by the due date, the Online Service System 214 will send a reminder 230 to the customer; and, if the customer 204 still does not pay, the invoice will go to an enforcement process (not shown) that may end with debt collectors or other proceedings.

An exemplifying embodiment of the inventive concept as described herein comprises the following interaction stages between the customer's access device 208 (user device 208), the merchant system 206 and the Online Service system 214.

Stage 10: Customer Purchase Order for Selected Item of Goods

A Customer selects one or more items of goods for purchase in interaction with a form rendered as a webpage hosted by the merchant system 206 and presented by an internet browser running on the access device 208 of the customer. The customer activates a control button on the form to send a indication of the intention to make a purchase to the merchant system 206 and thereby trigger a checkout process.

Stage 100: Initialize Checkout

In response to the received indication of the intention to make a purchase the merchant system 206 initializes or updates a checkout order in the merchant system 206 and sends a request comprising a selection of control data to the Online Service System 214 to initialize or update a corresponding checkout order in the Online Service System 214, whereupon the Online Service System sends a confirmation message back to the merchant system 206.

Stage 200: Render Checkout in Interaction with Customer

In response to the received confirmation message the merchant system 206 retrieves the initialized or updated checkout order and sends a request comprising a selection of control data to the Online Service System 214 to respond with a corresponding checkout order in the Online Service System 214, whereupon the Online Service System sends a confirmation message back to the merchant system 206, which then renders the checkout order on the display of the access device 208. In one or more alternative embodiments the Online Service System 214 renders the checkout order directly on the display of the access device 208.

Stage 300: Completion of the Purchase

Upon a determination of approved credit (330) for the transaction/purchase the Online Service System 214 sends a push request to the merchant server system 206, which retrieves the corresponding checkout order and sends the checkout order, in the form of control data, to the Online Service System 214. The Online Service System 214 updates a purchase release parameter in the checkout order and sends the checkout order to the merchant server system 206. The merchant server system 206 creates an order, initiates shipping and confirms a completed purchase by sending a completed purchase parameter to the Online Service System 214. Online Service System 214 updates the checkout order status parameter to created

Stage 400: Render Checkout Confirmation in Interaction with Customer

Upon completion of the payment process the Online Service System 214 sends a payment completion request to the merchant server system 206. In response to the received payment completion request the merchant system 206 retrieves the initialized or updated checkout order and sends a request comprising a selection of control data to the Online Service System 214 to respond with a corresponding checkout order in the Online Service System 214, whereupon the Online Service System sends a confirmation message back to the merchant system 206, which then renders the checkout order on the display of the access device 208. In one or more alternative embodiments the Online Service System 214 renders the checkout order directly on the display of the access device 208.

Example Transaction Flow

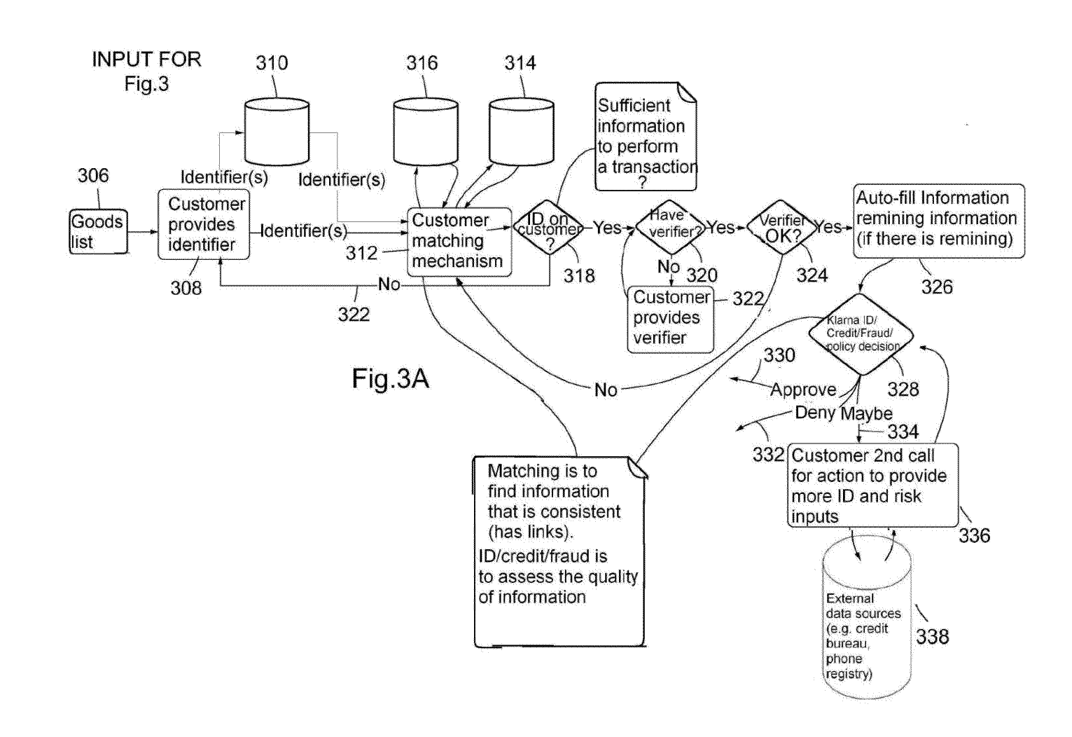

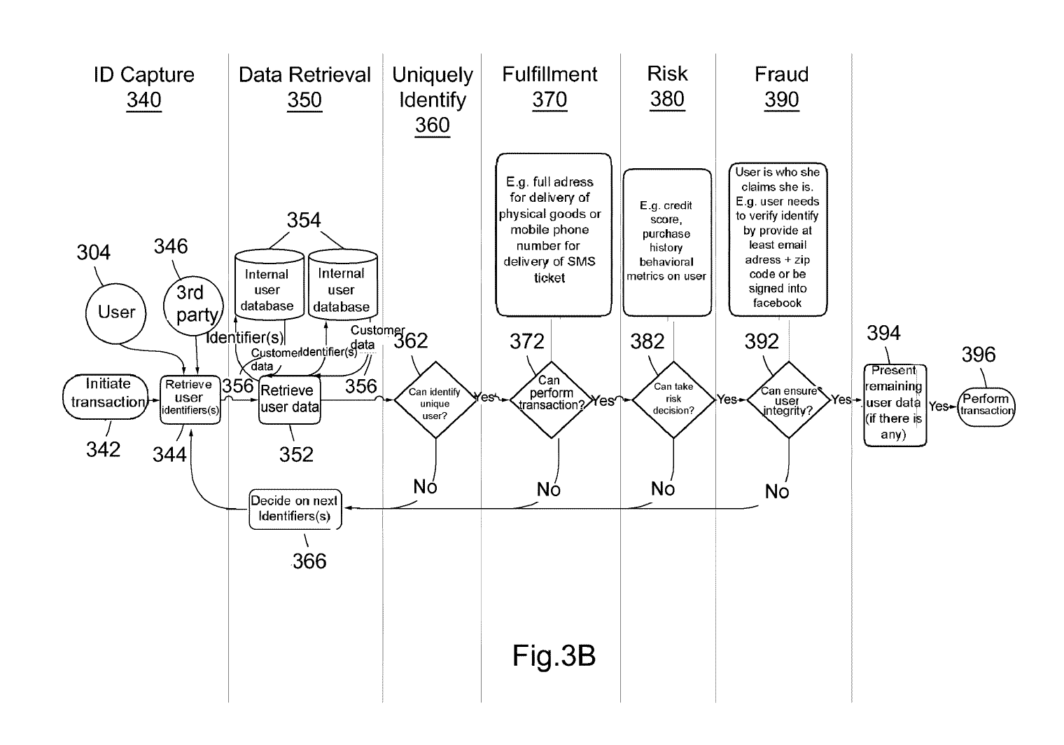

FIG. 3(a), provides an overview example of the various steps in the transaction flow of the system 202 described above may entail.

In FIG. 3(a), after a customer (not shown) chooses one or more items from a goods list 306, the system requires, at 308, the customer to provide a single item of customer identification information, herein also called a customer identifier. As illustrated below, this identification information does not necessarily have to be a manual input from the customer, but could come, usually with the customer's permission from an external source 310, like a third-party social network site. This identifier could also be provided by the customer's device, e.g., a device identifier for a mobile handset or a subscription identifier associated with the customer e.g. a mobile network services subscription being operated from a customer access device 208. It does not need to be a single item identifier but the system can also accept multiple identifiers in the initial step. One example of such case would be when a customer is signed in with his merchant account. The merchant can then provide the system the customer information associated with the account when the checkout session is initiated. The main point is that the system can accept any set of customer identifiers, and sometimes a single identifier may be sufficient to complete the transaction.

A more detailed way of describing the manner the user is choosing one or more items from a goods list 306 is as follows. A customer 204 performs an input at the access device 208, communicatively coupled to the merchant server system 206 and to the Online Service System 214, indicating to the merchant server system 206 and/or the Online Service System 214 a set of items from a goods list that the user desires to purchase, a selection of customer control data and a confirmation of the intention to perform a purchase, also referred to as an indication or control signal triggering a checkout session initiation for example in the form of a purchase order request. In one or more embodiments the merchant server system 206, based on the user indicated set of items from a goods list, customer control data and checkout session indication, then sends the customer purchase order request to the Online Service System 214. In one or more embodiments the access device 208 of the customer, based on the user indicated set of items from a goods list and customer control data then sends a customer purchase order request directly to the Online Service System 214.

In one or more embodiments the Online Service System 214 receives the customer purchase order request from the merchant server system 206 and/or from the access device 208. In one or more embodiments, the Online Service system 214 further receives customer control data, e.g. comprising or consisting of customer information. The Online Service System 214 receives customer control data, also referred to as customer information.

The customer control data might be received through:
indication by the user via the access device 208 to the Online Service System 214
indication by the user via the access device 208 to the merchant web site
the merchant server system 206 accessing the merchant database
being received, usually with the customer's indicated permission, via a request to and corresponding response from an external source 310, like a third-party social network site, or through a combination of all.
   The customer control data may be included in the purchase order request or in a separate control signal to the Online Service System 214.

In the case using an external source 310 such as a database pertaining to a social network, one or more embodiments comprises the third party request being validated by the external source 310 (third party) based on customer control data included in the third party request, based on data records stored in the Online Service System 214 and included in the third party request, or based on a predetermined relationship between the Online Service System 214 and the external source 310. One or more embodiments comprises the Online Service System 214 receiving from the customer access device 208 customer control data in the form of customer login data and possibly an access permission parameter indicating the customer's express permission to access for example an account of the customer at the external source 310 for the purpose of obtaining customer identification data.

With this information the system 214 by means of a customer matching mechanism, then tries, at 312, to match that customer identification with a known individual dependent on received customer identification data. It does this by preferably checking with its own internal database 314 or, in certain cases, an external database 316 e.g. a credit bureau, a phone registry, by means of one or more database query requests. The database could be a virtual database, for example in a cloud environment or distributed, or it could be a physical database in one location.

A more detailed way of describing the manner of matching of the customer identification could be described as matching the received first set of customer control data to records in a database and upon a successful match deeming and indicating the customer as identified with a known individual, wherein a successful match includes that particular matching conditions according to a predefined set of rules have been met. In one example, matching conditions are defined in the rules as sufficient information to perform a predefined transaction for delivery and for identifying the paying party, such as a shipping address for physical delivery of goods or a mobile phone number. In one example matching is performed by sending a request comprising the received customer control data to the database and receiving in return a matched set. In one example the database is an internal database of the Online Service System 214 or an external database communicatively coupled to the Online Service System 214. In one example the received customer control data comprises user account information from the external source 310 (e.g. from a user account at a third party social network) used to match to records in a database. Matching customer control data to match records in a database may be performed in any manner known to a person skilled in the art.

Moreover, the system is designed and configured so that the customer need not be a returning customer, nor is it necessary that the customer has established a user account/registration with the system 214. Indeed, the customer may have no externally existing account with any vendor at all.

This is enabled, as explained above, by dividing the purchasing process such that the merchant server system 206 handles the purchase order and the shipping of purchased piece s of goods, and such that the Online Service System 214 handles the purchase release and payment process. The purchase release process comprises e.g. customer identification, customer identity verification, credit assessment/determination and indication of purchase release. The payment process comprises settling payment in various ways. e.g. by issuing a credit for the purchase. Examples of various settlement/payment methods are described further below.

If, as a result of this process, the system 214 is configured to determine, at 318, that it can identify the customer, it moves on to check, at 320, whether it has a “verifier” for the customer. By identification is meant, sufficient information to perform a transaction for example. This typically includes more information than merely a customer identification. For example, this could include information such as a shipping address for physical delivery of goods or a mobile phone number for something like an SMS text message delivery of a bus ticket.

If the system 214 cannot identify the customer with the provided information, the system returns back to the step where the customer has to provide the initial information (at 308) and prompts the customer to provide for additional information. This loop 322 is repeated until the system has enough information to identify the customer. Once the customer is identified, as indicated above, the system 214 may check (at 320) whether it has a verifier for the customer. This verifier can be a second piece of information—often not obvious from or derivable from the customer identifier determined at step 308—that is used to verifier the customer is who he or she says they are and is used, amongst other purposes, for fraud detection/security/integrity verification. The verifier could, for example, be a zip code when the customer identification is an e-mail address. Typically zip codes are not obvious or derivable from e-mail addresses. As described in greater detail below, the verifier could also have been collected at the same time that identification is established. This example embodiment may include using few customer inputs to complete a transaction.

If at step at 312 a successful match has been obtained so that it can be determined 318 that the customer is identified, the Online Service System 214 further determines, at step 320, whether a verifier data item for the customer is available in the received customer control data, and/or in the internal database and/or in the external database/s. In one or more embodiments the verifier data item may be used in combination with the received customer control data to determine a fraud attempt, for security verification and integrity verification. In one example the verifier data item may be a zip code. In one example a verifier data item indicated by the user is compared to the corresponding verifier data item stored in the internal or external database/databases and if they match the Online Service System 214 determines that the customer purchase order is not fraudulent.

If the system does not have a verifier, it may prompt the customer (at step 322) to provide the verifier. Whether provided by the customer or determined through other means, the verifier can be checked at 324. If it is acceptable, the system 214 can auto fill (at 326) all other relevant user details into address and other fields displayed to the user. In one example embodiment, this auto filled information can be kept to the minimum required, for example including shipping address and possibly a few of the numbers of a mobile phone number. If available, it could also reflect other user identification information, such as a photograph pulled from some other social networking website, such as Facebook. If the verifier is not acceptable, the system can return to the customer identification matching process at 312 to supplement the user information to obtain a more accurate identification of the customer so as to ensure that the system is interacting with the specific customer that had been identified. This is one way of reducing fraud.

In one or more embodiments when it is determined 318 that a verifier data item for the customer is not available in the received customer control data, and/or in the internal database and/or in the external database/s, indicating that the customer is not identified, the Online Service System 214 is configured to trigger 322 the customer control data collecting function in the Online Service System 214 or merchant server system 206 or to receive customer control data including a verifier data item.

When it is determined that a verifier data item for the customer is available in the received customer control data, and/or in the internal database and/or in the external database/s indicating that the customer is identified, the Online Service System 214 further compiles a user information data set 326 and provides an access device display request including the user information data set, wherein the user information data set includes items from any of customer control data, data records stored in the Online Service System 214, data obtained from internal database/databases, data obtained from external database/databases or data from external sources 310. In one or more embodiments the access device display request is sent from the Online Service System 214 to the access device 208. In one or more embodiments the access device display request is sent from the Online Service System 214 to the access device 208 via the merchant server system 206.

If verification happens, the system 214 can make a credit/fraud policy decision at 328. This decision can occur as soon as the information is received and processed. This decision is typically based on a number of considerations, including the size of the transaction, any credit limit previously allocated to the user by the system, the type of merchandise, the recent frequency of transactions for the user, etc. Based on that decision, the system 214 can either approve (330) or deny (332) credit for the transaction. It could also make a “Maybe” determination in which the customer is asked for further information (at 336), and the system accesses additional—usually external—resources 338 to make a final “approve” or “deny” decision.

In one or more embodiments, after providing a access device display request the credit assessment or credit determination functions of the Online Service System 214 further performs a credit/fraud policy determination/decision 328 resulting in a determination of approved credit (330) for the transaction/purchase, denied credit (332) credit determination for the transaction/purchase or “Maybe” credit determination for the transaction/purchase. In one or more embodiments the credit assessment function or credit determination functions of the Online Service System 214 performs credit/fraud policy determination/decision by setting a value, e.g. corresponding to or dependent on the price of the selected goods, to a reservation for credit parameter assigned to the current customer and possibly to the current purchase dependent on a set of predetermined rules. In one example these predetermined rules would comprise an assessed current credit line for the customer exceeding the price of the piece of goods selected for purchase.

In one embodiments, a purchase release parameter is set to a value corresponding to a determination of approved credit (330) for the transaction/purchase and communicated to the merchant server system 206 e.g. in response to the value of the reservation for credit parameter being successfully set, whereupon the purchase is controlled to be completed by the merchant server system 206.

In one or more embodiments, in the case that a value for the reservation for credit parameter cannot be successfully set, optionally an alternative method of settlement/payment is offered to the user 304 and if successful alternative settlement/payment is achieved a purchase release parameter is set to a value corresponding to a determination of approved credit (330) for the transaction/purchase and communicated to the merchant server system 206, whereupon the purchase is controlled to be completed by the merchant server system 206. If an alternative settlement/payment is not achieved a purchase block parameter is set to a value corresponding to a determination of denied credit (332) for the transaction/purchase and communicated to the merchant server system 206.

In one or more embodiments, in the case that a value for the reservation for credit parameter cannot be successfully set, a purchase block parameter is set to a value corresponding to a determination of denied credit (332) for the transaction/purchase and communicated to the merchant server system 206.

Similarly, in one embodiment in the case that a value for the reservation for credit parameter set to a value corresponding to a determination of Maybe” credit for the transaction/purchase, the Online Service System 214 is configured to trigger 336 the customer control data collecting function in the merchant server system 206 or preferably in the Online Service System 214 to receive additional customer control data and repeat the credit/fraud policy determination/decision step 328 described above.

Alternatively or as a complement, a purchase block parameter may e.g. also be set in the merchant server system 206 dependent on a time out function running out.

In one embodiment the completion of the purchase involves the merchant server system receiving a purchase release parameter and initiating shipping of the purchased goods as well as preferably communicating a confirmation of completed purchase parameter being communicated from the merchant server system 206 to the Online Service System 214 and typically shipping of the purchased piece of goods is initiated. In response to the confirmation of completed purchase parameter being received by the Online Service System 214, the Online Service System 214 carries out a payment process for example comprising obtaining payment from the customer via a selected transaction process as well as triggering payment to the merchant for example via a transaction from the Online Service System 214 to the merchant server system 206 or via other fund transfer system associated with the merchant.

Thus, if the transaction is approved, the customer is able to make the purchase using any of the various payment methods described below. These typically include buy now-pay later; pay over an extended period, pay by credit card, pay by EFT (electronic funds transfer), etc. For example, if the customer is denied credit, this does not preclude the customer from making the purchase. For example, under those circumstances the customer could still purchase the desired goods using a credit card, something like an online payment system such as PayPal, or another EFT payment. One example feature is that the system can approve the transaction without knowing how the customer wants to settle it (pay it by bill, credit card, PayPal, etc.). Paying is a large friction point in the checkout process, and decoupling/separating buying from paying is a key feature. This is enabled by issuing a credit for example. In the current implementation of a checkout, the system can default the customer to a 14 days credit.

In one or more embodiments, after the Online Service System 214 has made determination of approved credit (330) for the transaction/purchase a settlement function is activated. The settlement function sends a settlement method request, including a set of settlement items representing different options for payment settlement, to the access device 208, whereby the access device displays the settlement options via a graphical user interface to the user i.e. the customer. The user makes an input to the access device, indicating a selected settlement item. The access device sends a settlement option response, including a selected settlement item to the Online Service System 214. The Online Service System 214 receives the settlement option response from the access device 208. The Online Service System 214 further triggers payment to the merchant for example via a transaction from the Online Service System 214 to the merchant server system 206 or via other fund transfer system associated with the merchant.

As is apparent from the description above, some example characteristics of this system include the fact that the purchase order can be accepted and the goods 212 may be shipped to a customer 204 before funds for purchase have been reserved. In addition, the purchase order/transaction can get assessed (accepted/denied) by assessing the goods 212 list value and other current purchase characteristics (goods type, the type of merchant, etc), and external and internal customer-unique scoring history. Typically, the payment method is not a factor used for determining acceptance/denial of the transaction. But, in certain cases, the system 214 can require the customer to select a payment method before making the decision to accept/deny the transaction.

The system may also be characterized as having “dynamic” account retrieval. Thus the Online Service System 214 can push customer identification information to the customer 204 based on incremental (small amounts of) account information provided by the customer 204. From the customer's 204 point of view, therefore, it appears that no user name or passwords are required to make purchases (transactions), and that shipping information can be confirmed during verification of identity.

Thus, the Online Service System 214 uses credit worthiness checking to make it safer and easier to buy and pay after delivery. This can reduce the “friction” to buying by separating the act of buying from paying. As is described above and in more detail below, the Online Service System 214 only requires customers 204 to input information actually needed for the transaction and, as explored below, increments the required input information gradually until enough information has been obtained to identify the customer and determine the credit risk of the customer and transaction pair. But, as discussed above, the system does not create or require a unique and exclusive user ID and password, but still asks for information that may be inherently unique to a customer, such as, the e-mail address for example. That unique information can then be verified/validated by other customer-provided information such as the ZIP code. To make it easier, the Online Service System 214 can pre-fill information about the customer in the checkout form as soon as a customer is identified with sufficient verification. On identification, the risk-assesses the customer instantly and, depending on the risk assessment, the customer can get different ways to purchase as described in greater detail below. Also, as described in greater detail below, the customer 204 can also aggregate multiple transactions across multiple merchants and settle entire debt at once, e.g. end of month.

FIG. 3(b), provides an overview of an embodiment slightly different to the transaction embodiment of the flow illustrated in FIG. 3(a). The order of the described steps can vary in different embodiments.

As illustrated in FIG. 3(b) the transaction flow comprises a series of discrete phases or steps, namely an ID capture phase 340, a data retrieval phase 350, a “uniquely identify” step 360, a check for fulfillment information 370, a risk assessment step 380, and a fraud check 390.

During the ID capture phase 340, in response to the initiation of a transaction at 342, the system obtains a user identifier at 344, either directly from the user 204 or from a third party source such as a social media site 346. During the data retrieval phase 350, the system uses the user identifier from step 344 to retrieve additional user data at 352. Typically this is done by passing the user identifier (from step 344) to internal databases 354, which, when a match is found, return customer data 356 for use by the system.

During the subsequent “uniquely identify” step 360 the system uses the user identifier from step 344 and the retrieved user data from step 352 to make a determination at 362 as to whether the specific user 204 can be identified uniquely. If the system determines that not enough information is present to identify the user 204 uniquely, the system prompts the user via step 366 to enter additional information using the user device (not shown). This iterative process—from step 344 through steps 352 and 362—is repeated until enough information has been retrieved, either from the user or from the system's internal databases 354, to identify uniquely the specific user 204. This is to guard against a situation where more than one user has the same user identifier or where two people have identical names.

During the Fulfillment check 370, once the user 204 has been identified uniquely at 362, the system determines at 372 whether it has enough information to fulfill the transaction that was initiated at step 342. Typically this would entail checking whether the system has, for example, the address for the delivery of physical goods or user's mobile phone number for the delivery of an SMS or some other form of electronic content. These two examples of “addresses.” Others could include an e-mail address or any other address suitable for delivery of the goods required by the initiated transaction 342. Once again, if the system determines, at 372, that it does not have enough information to fulfill the transaction the system would prompt the user via step 366 for additional information. As before, this process is iterated until enough information exists to fulfill the transaction initiated at 342.

Thereafter, during the risk assessment step 380, the system using internal algorithms makes a decision whether it can “take” the risk for the specific user 204 and the initiated transaction 342. At step 382 for example the system would consider the user's credit store score, purchase history, other behavioral metrics, and even the size of the purchase. Other considerations could also apply. Once again if not enough information exists to make the risk decision at 382, the system returns to the user via step 366 to request additional information. As before, this process is iterated until enough information is available to allow the system to make the risk decision.

Once the system has made the determination that the risk is sufficiently low to process the transaction, it moves to the fraud detection step 390. During this step 390 the system does a check at 392 to ensure that it can “vouch” for the user's “integrity. Step 392 is to ensure that the user 204 is who the user claims to be. In some circumstances, the system will require the user to provide additional information for fraud checking purposes. As described herein, such additional information would be by its nature not derivable from the user identifying information supplied at step 344. Thus, for example, if the user provided an e-mail address at step 344, the system could ask for a postal or zip code so as to be able to allow the system to check against false use of a person's identification. Another way of conducting this fraud detection would be to determine whether the user logged in via Facebook or some other social media site. Once again if the system cannot ensure the users integrity at 392, it returns to the user via step 366 two us for additional information.

After the system has run the fraud checks 390 and a degree of certainty has been reached that the user 204 is who the user claims to be, the system can optionally (at 394) present remaining user data to the user 204 for final verification by the user. If that information is (optionally) verified the transaction can be performed at 396. As described herein, there are certain situations where such additional verification step 394 is not necessary or sometimes undesirable.

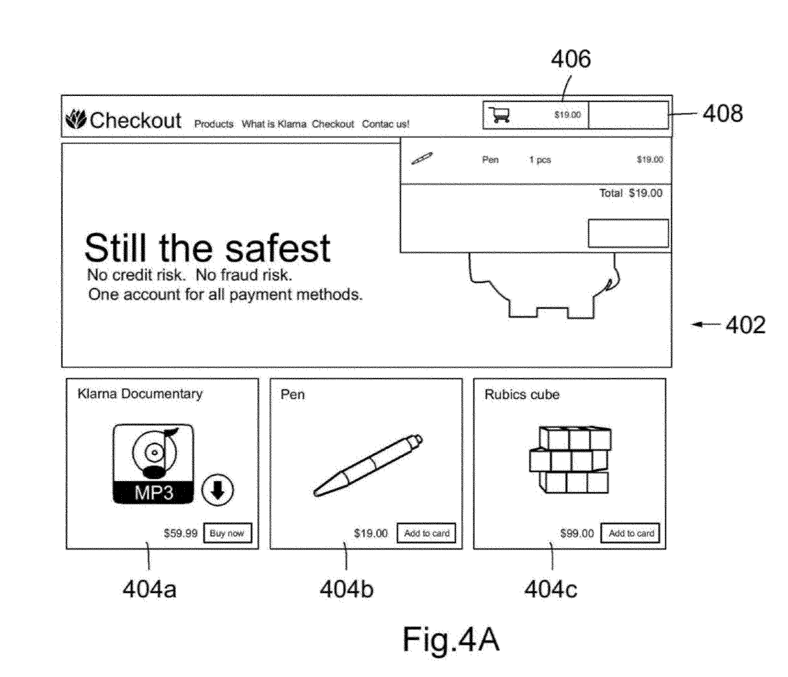

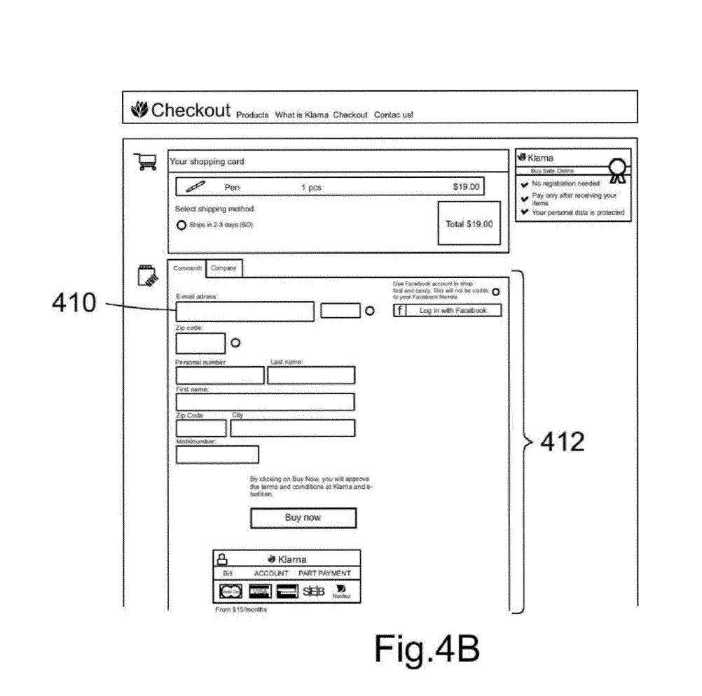

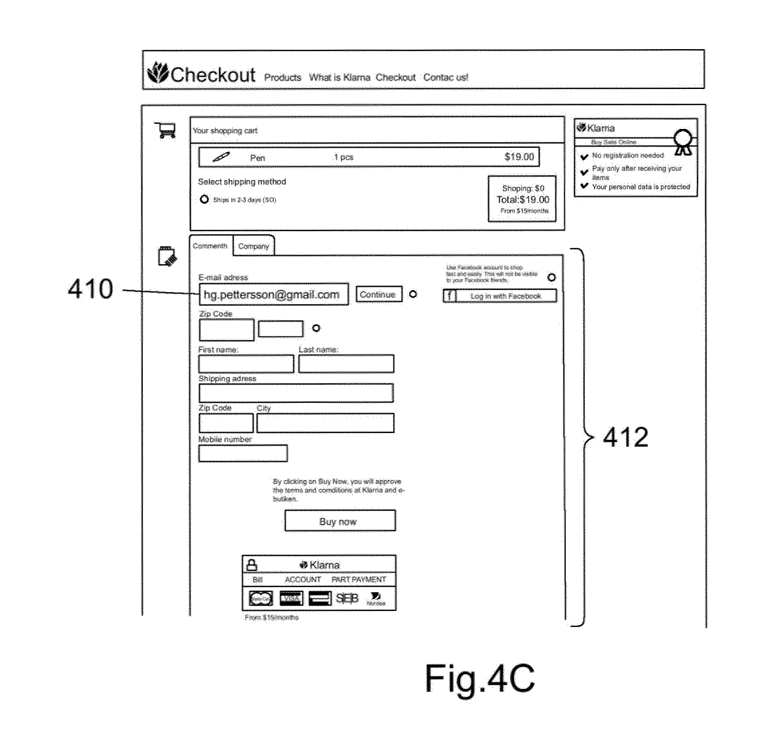

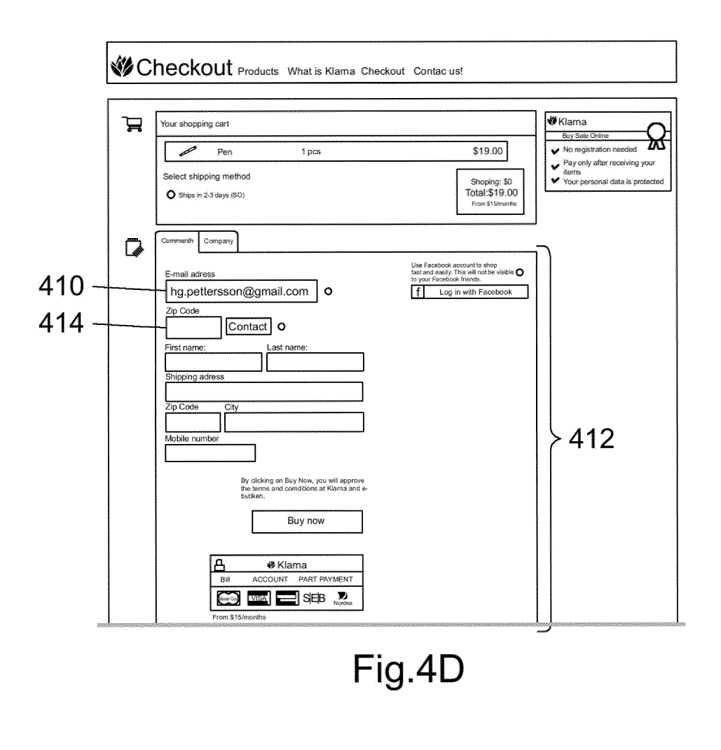

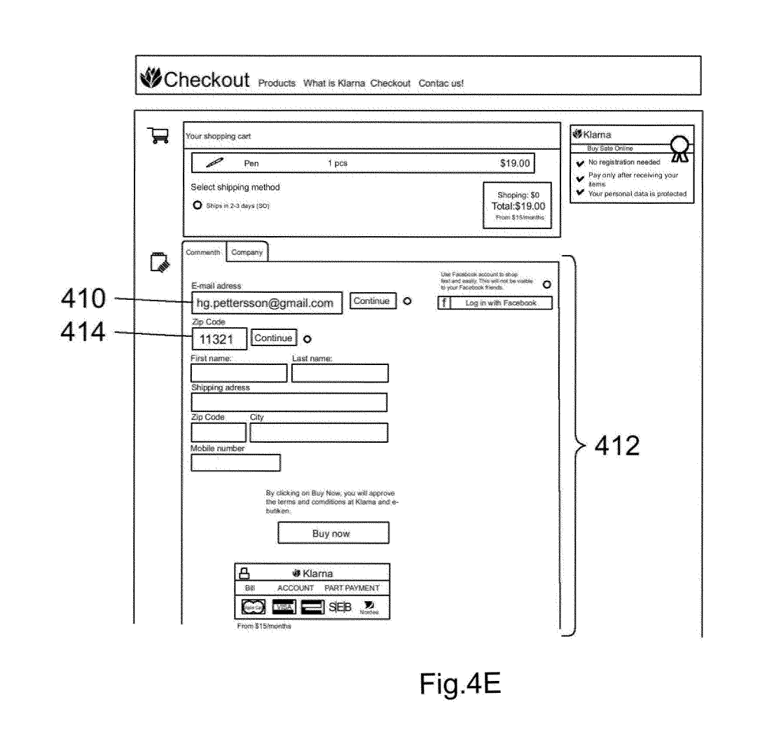

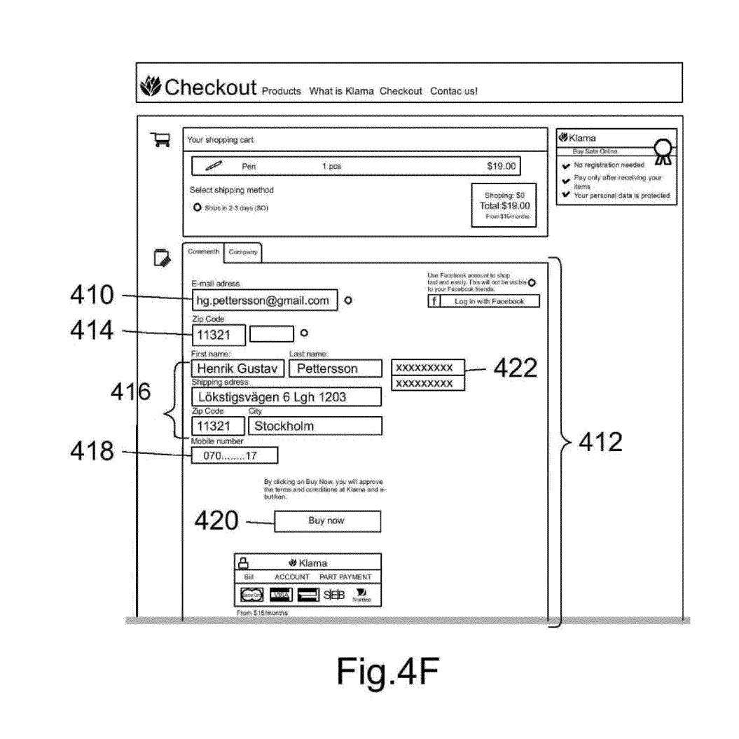

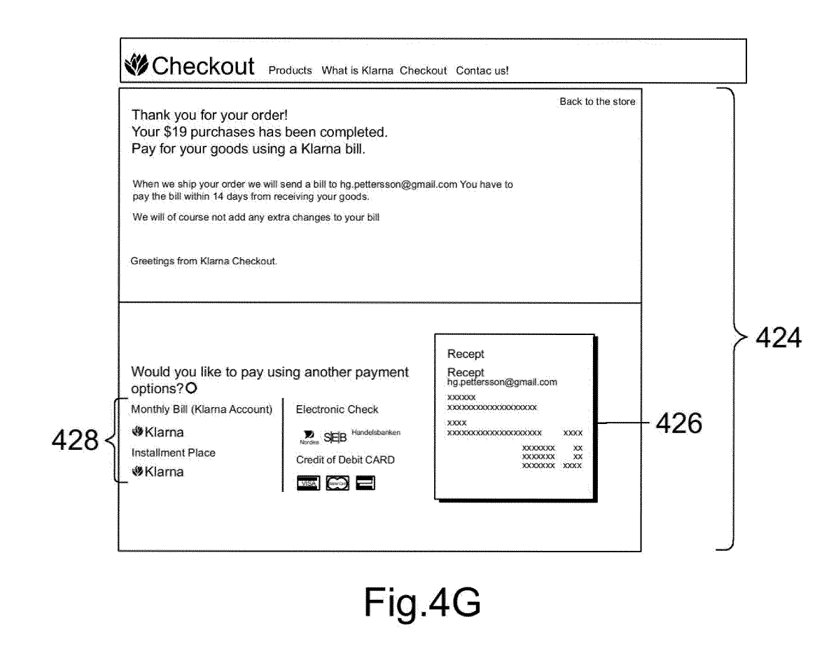

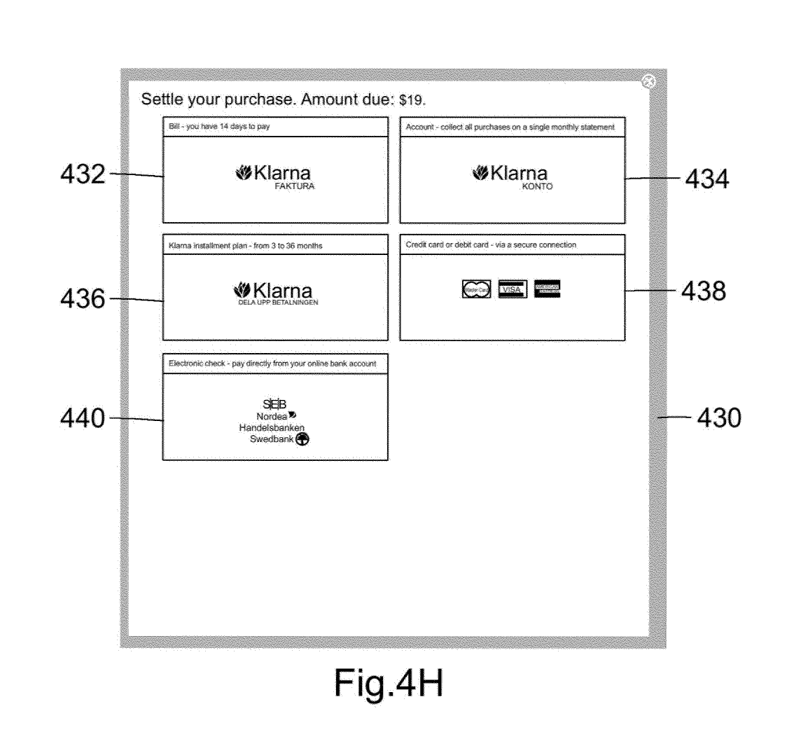

Further details of the customer experience are illustrated with reference to the screens shots in FIGS. 4 to 8 below.

### More Examples of Customer Experiences

Various non-limiting examples of the customer's experience with the Online Service System 214 can be illustrated with reference to the screenshots in FIGS. 4A to 4I as well as subsequent Figures.

Specifically, the screen shot 402 shown in FIG. 4A offers a selection of items 404a, 404b, 404c for purchase by a customer 204 (not shown in these Figures). When the customer selects an item to purchase (in this case the pen shown at 404b), the item can be automatically added to the customers shopping cart 406. When the customer 204 selects the “go to checkout” button 408, the screen can change to that represented in FIG. 4B.

As shown in FIG. 4B, the customer 204 can now be given the opportunity to identify him/herself. To keep the process as simple as possible, the customer 204 can be directed to fill in a first item of customer control data in the form of an e-mail address in an e-mail address block 410 at the top of the customer identification section 412. The customer 204 can then enter an identifying e-mail as shown in FIG. 4C. Once this is done, and as shown in FIG. 4D, the customer 204 can be prompted to enter a second item of customer control data item, also called a verifier, in the form of a Zip Code at block 414. This is shown in FIG. 4E.

The use of the combination of the e-mail address and Zip Code pair is to reduce the chance of fraudulent transactions. These two fields are typically unrelated and not easily hacked/correlated, but are usually associated at various data sources accessible by the Online Service System 214, as exemplified above. Thus, the pairing can be a good way of uniquely identifying the customer 204. As will be illustrated below, many different pairings may be used, and this is only one example. Indeed, under certain circumstances this example pairing maybe inappropriate and geo-location and IP address checking could, for example, be used instead, once again as illustrative examples.

In response to the customer 204 entering the e-mail (410) and zip code (414) pair, the system, in its databases (as explained with respect to FIG. 3), can look up the name and address details for the customer 204. As shown in FIG. 4F, the system can automatically populate the information in the address fields 416. This auto-population can be useful both to the customer, who does not have to fill in any additional information, and also to act as an integrity check so that the customer can confirm that the appropriate identification has been achieved. For example, the auto-population process does not necessarily occur until this verification has happened, thus preventing a third party from merely entering an e-mail address to obtain someone else's address information. Also as shown in this Figure, the address fields may be “grayed out,” indicating that they cannot be changed by the customer, thus providing a further level of security. Under certain situations, a customer may be allowed to change this information, but if that does occur, additional security checks may be required before credit is advanced by the system 214. Examples of when grayed out information could be changed include a change of mobile phone number, a change of family name due to marriage, a change of residential (or shipping) address, etc.

This FIG. 4F also shows that the customer 204's mobile phone number (or at least a portion of it) is reflected in a block 418 the customer identification section 412.

If the customer 204's details are correctly populated, the customer 204 can select the “buy now” button 420 and proceed to the confirmation screen shown in FIG. 4G. For example, at this point, the customer 204 has not had to log in to the system, nor provide payment, shipping address, information at all. Instead the customer 204 has been identified automatically using only an e-mail address and a zip code. Moreover, the system, in addition to obtaining the customer 204's details may also have completed a credit worthiness check—as described elsewhere—on the customer 204 based on the customer 204's details, past history, publically available credit information and the size and type of purchase. All this happens as the information is received and is transparent to the customer 204 and the merchant at whose website the customer 204 is making the purchase.

In addition, the customer 204 may be given the opportunity to select a change customer button 422 should the system have identified the customer 204 incorrectly. This may reduce problems caused by customer misidentification. But, as indicated above, such changes may activate additional security procedures and require the customer to enter additional information/go through further credit verification processes.

Turning now to the purchase confirmation screen 424 example shown in FIG. 4G: the customer 204 may automatically be given the opportunity of paying using a delayed payment method with a bill payment represented by a “bill image” 426. This bill can be mailed to the customer either with the product and/or separately. It can also be sent via e-mail, SMS, third-party website message, etc. Under some circumstances, the system 214 could also activate an automatic debit transaction from the customer's bank account. As indicated above, the good(s) ordered by the customer can get shipped, physically or downloaded, to the customer before the customer has paid. But, based on the credit assessment done by the system, the merchant may be paid by the system and the customer can pay the system later. Thus the merchant does not necessarily bear the risk of customer default and, because the customer pays later, the customer does not bear the risk of lack of performance, such as failure to ship or damaged goods, by the merchant.

Also, in the case where a bill is sent to the customer periodically, a single bill for multiple items can be sent to the customer. In some cases, these multiple items could come from multiple vendors. Thus, the customer may settle with a single payment, the outstanding payments for multiple purchases across multiple vendors.

It is, of course, possible that the customer would want to use a different type of payment method. For this reason, payment screen 424 gives the customer an option to select other methods of payment 428. Should the customer select any of the alternative methods 428, a payment screen 430, as shown in FIG. 4H, can be presented.

This screen shows five different example payment methods, namely:
(i) a regular single purchase invoice option 432, which gives the customer 14 days in which to settle the invoice for the specific purchase;
(ii) a combined invoice option 434 which allows the customer to aggregate a series of purchases into a single monthly (or other periodic) statement as described above;
(iii) an installment plan option 436 allowing the customer to pay for the purchase in installments;
(iv) an option 438 to pay by credit card; and
(v) an option 440 to pay using an electronic check or other electronic funds transfer mechanism.

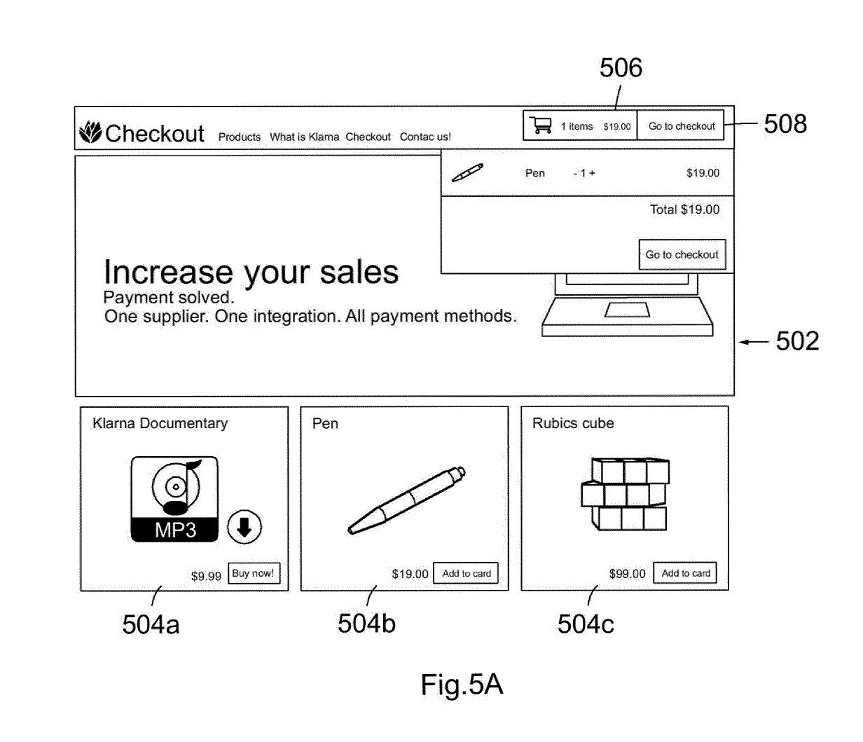

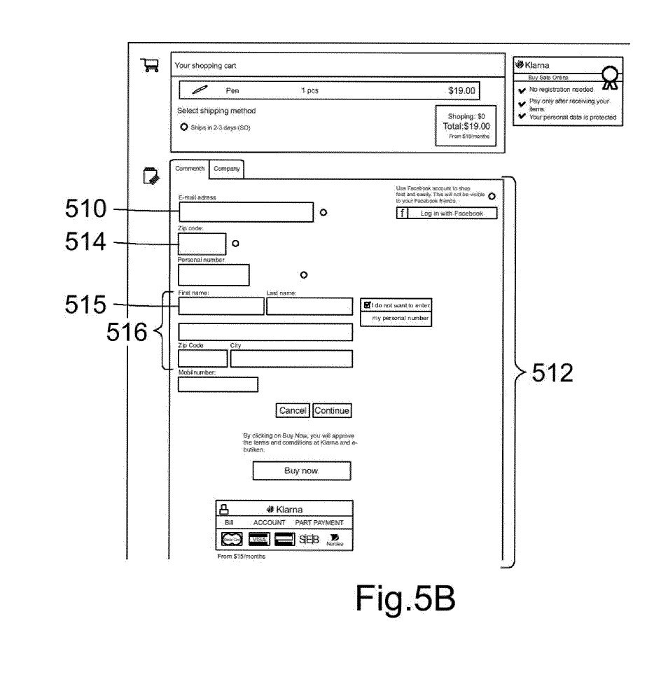

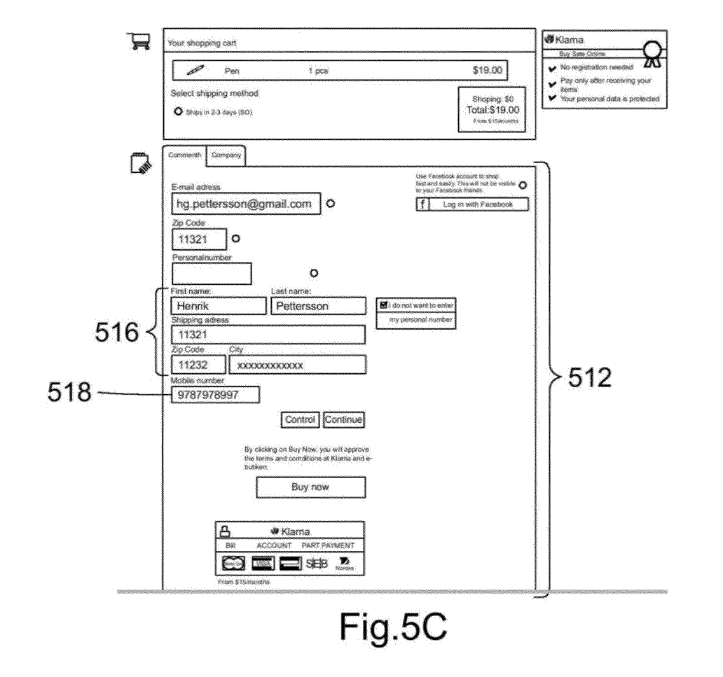

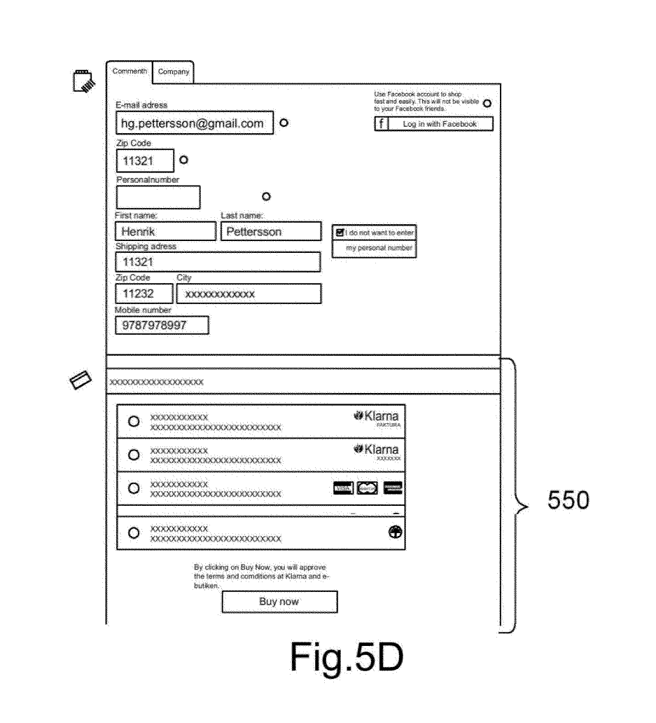

FIGS. 5A to D shows an example when a customer cannot be identified by the Online Service System 214. As before, the customer selects from a menu of options 502 and item 504b which is added to shopping cart 506. Upon selecting the “Checkout” button 508, the customer may be directed to enter an e-mail address in block 510 and zip code in block 514 as shown in FIG. 5B. But, in this example, the system is unable to identify the customer, so it prompts the customer for additional incremental information, for example a first name to be entered in block 515 in the personal information section 516. Thus, unlike in the example in FIGS. 4A to 4I, this section is not automatically filled out by the system.

If, for example, the system can still not identify this customer, it prompts, as shown in FIG. 5C, the customer to add all the customer's personal information in blocks 516 and mobile number in block 518, At this stage, as shown in FIG. 5D, the customer may be asked to choose a payment method in payment options sub-screen 550. If the customer chooses one of the immediate payment methods, payment by credit card for example, this is processed by asking the customer for credit card details, etc and the credit card transaction is proceeds and the goods are shipped according to usual e-commerce practices.

Under certain circumstances, when the customer chooses a delayed payment method, further credit checks may have to be done in real time and, only if those credit checks come up clear, will the goods be shipped to the customer. This process may require additional information from the customer and checking with third-party databases, credit rating systems, etc.

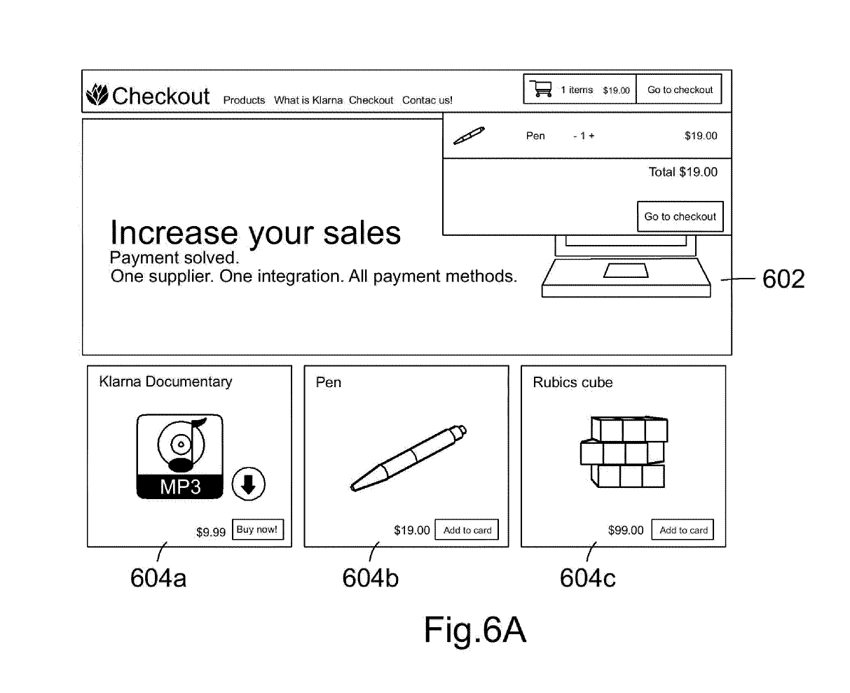

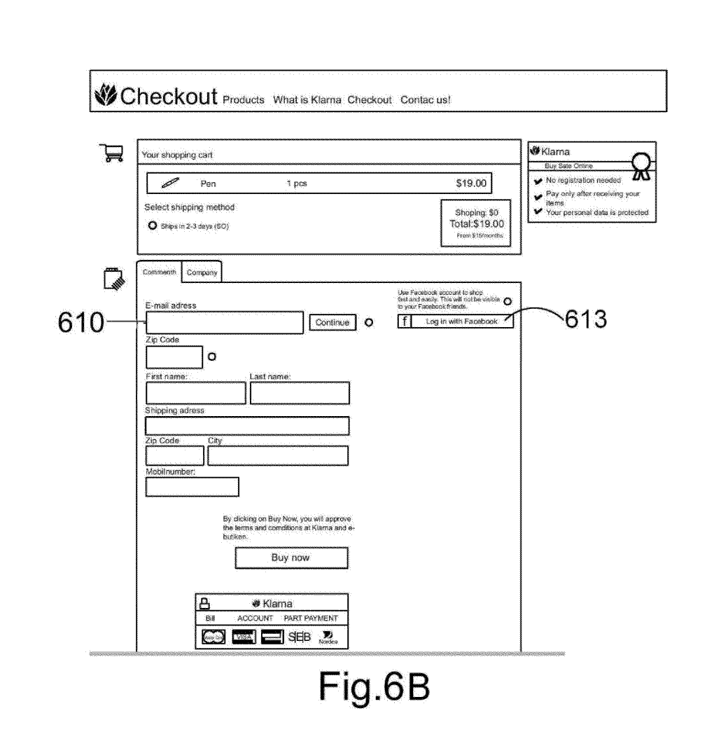

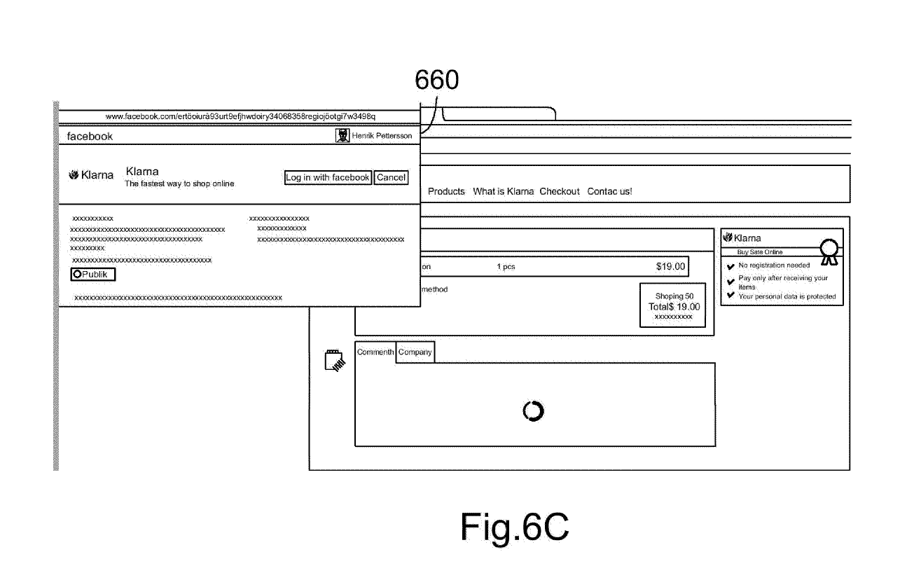

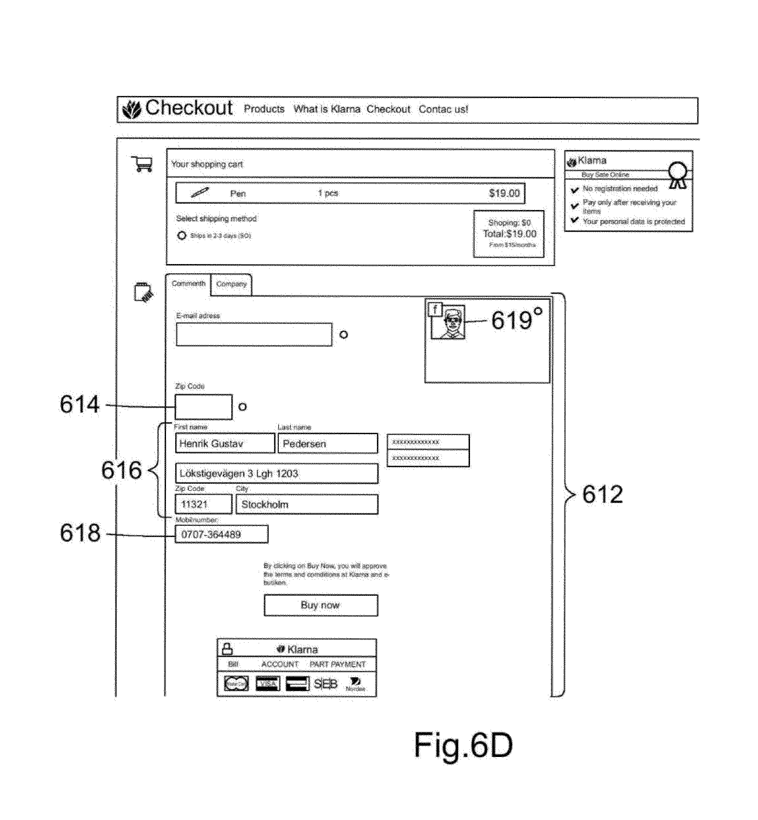

FIG. 6 shows how the Online Service System 214 can interact with and use a third-party social media platform like Facebook, for example. In FIG. 6A the customer, again without logging in, selects an item 604b and on check-out is presented with an e-mail address entry option 610 shown in FIG. 6B. But, instead of entering an e-mail address, the customer selects the “Log in with Facebook” button 613 and, after displaying a confirmation as shown in FIG. 6C, the Online Service System 214 retrieves the customer's e-mail address directly from Facebook, or other similar social network. Because such social media websites only operate on valid e-mail addresses, the system can use the already verified e-mail address retrieved from the third-party social network to look up and populate the remaining personal details 612—such as, for example, the zip code 614, personal address 616 and mobile phone number 618 fields as shown in FIG. 6D. Thus, logging in to a third-party social media website can act as the verification for system 214. The system can also pull the customer's social media profile picture 619 in and display them for the customer. This may act as a further visual verifier to the customer. The transaction can then proceed as previously described with reference to FIGS. 4A to 4I. Also, any kind of third-party verified website could work. The social media example shown here is only for example purposes.

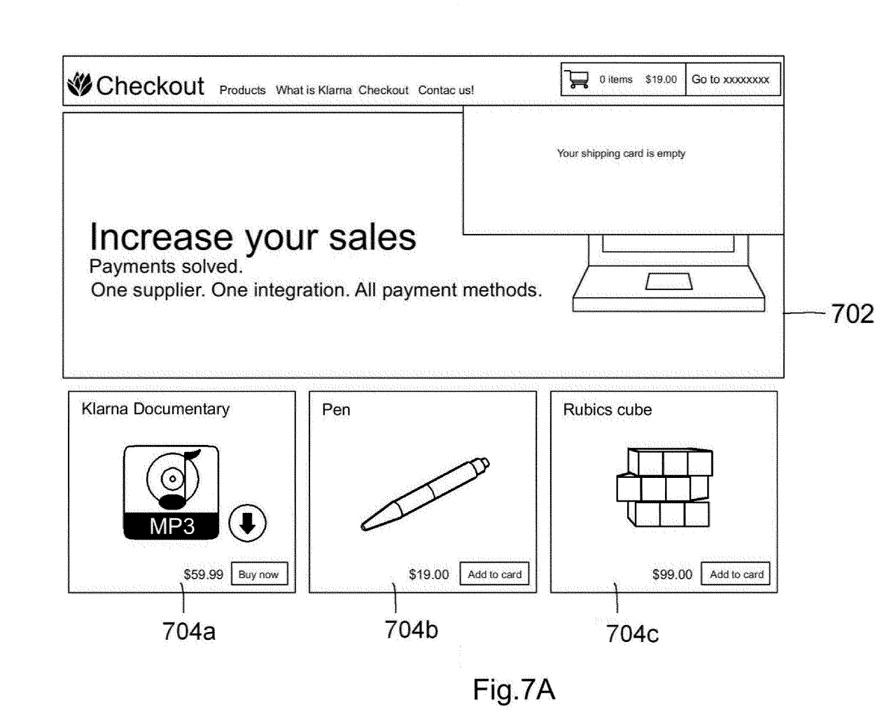

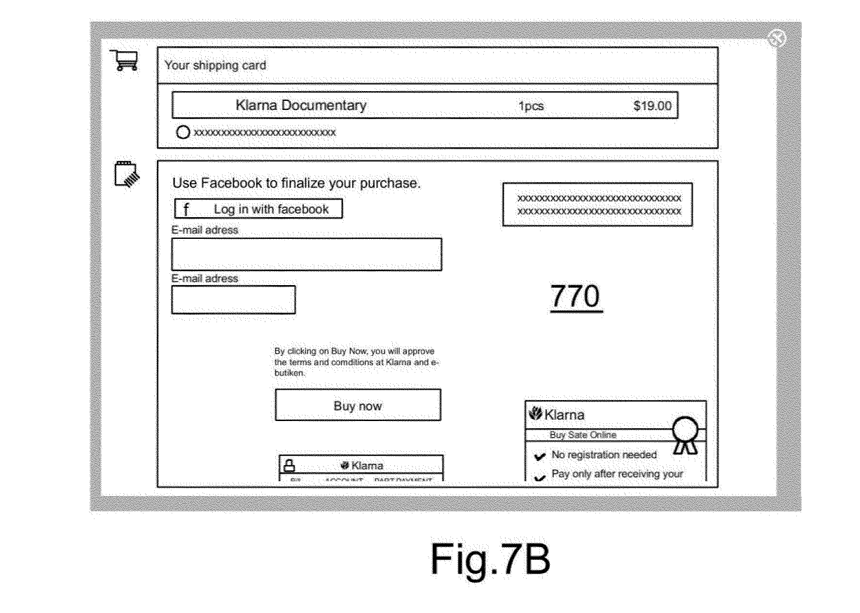

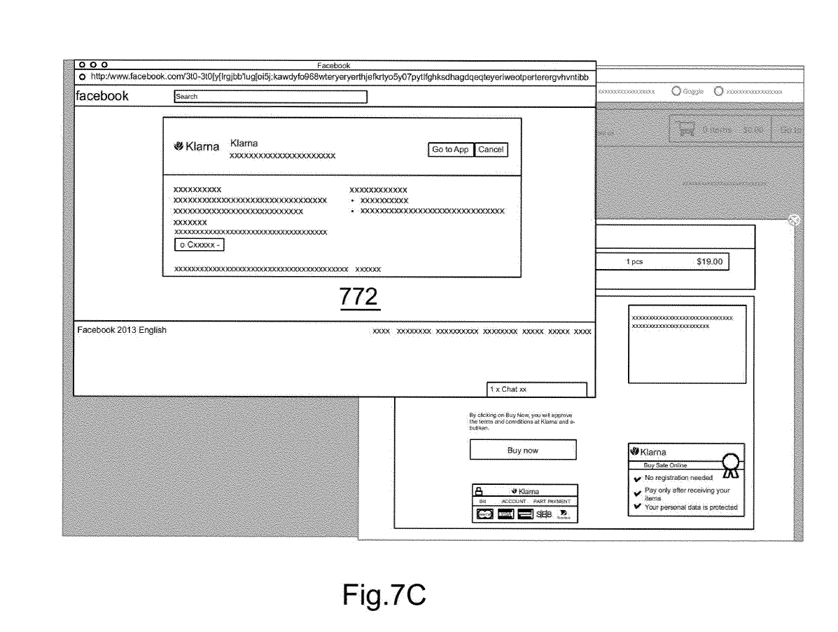

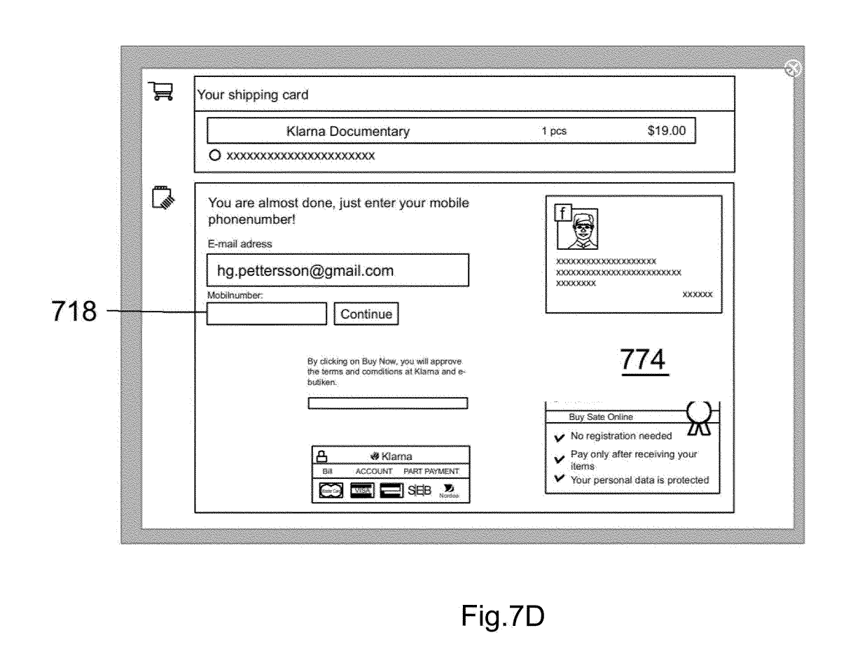

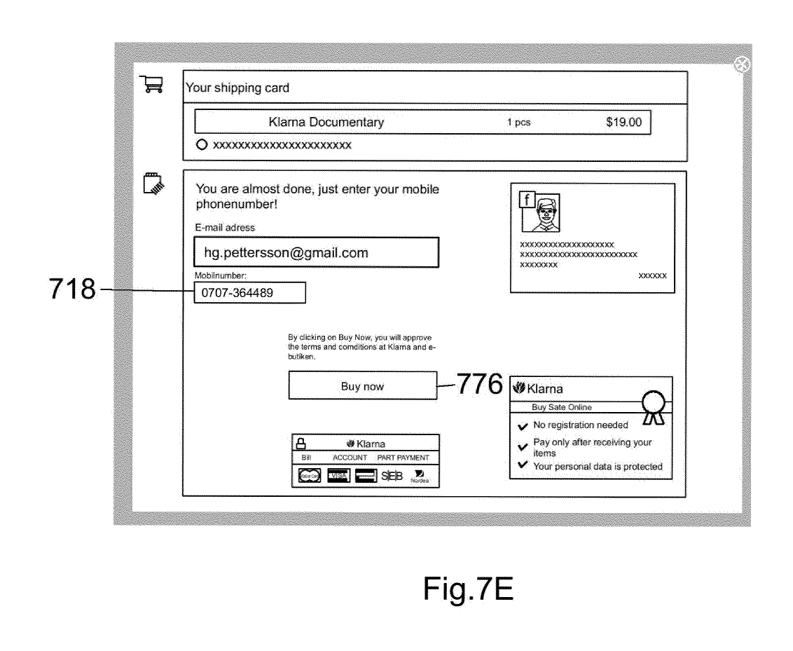

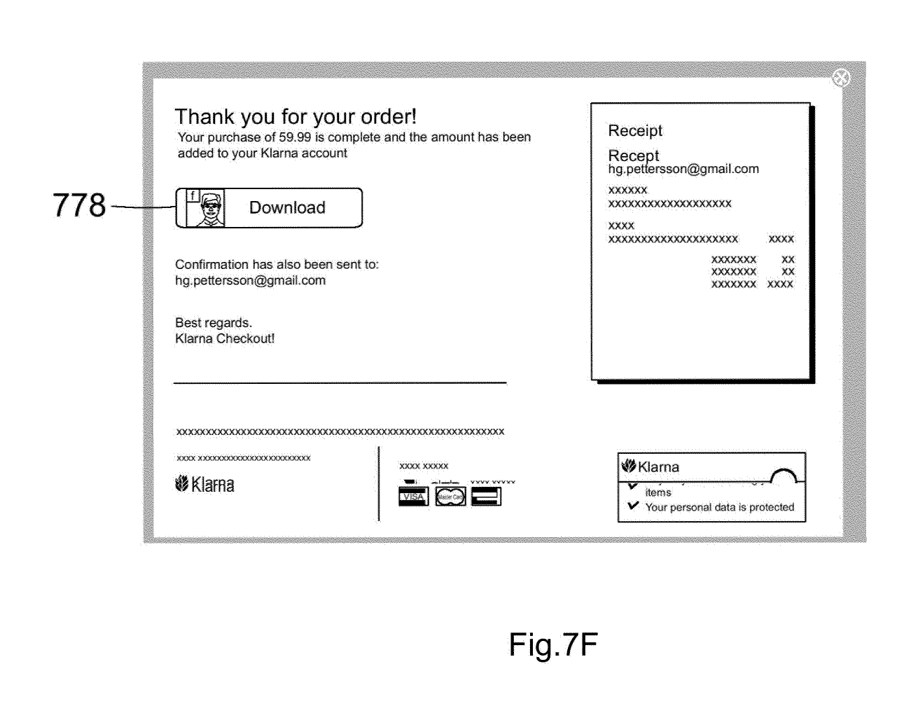

Although the illustrated process is not limited to digital content, FIGS. 7A to 7F show a purchase in which a customer chooses a digital content 704a, such as an MP3 audio recording, for example, and then, as shown in FIG. 7B chooses to log in 770 via a third-party social networking site. In this example it is illustrated with the user using a mobile device, but it is equally applicable to a non-mobile device. In this case, the system 214 asks the customer for a single additional piece of information, the mobile phone number 718 and, once that is entered the “Buy now” button 776 is made selectable, by changing its color from grayed out to full color, for example, as shown in FIG. 7E. Once the Buy Now button 776 is selected, the customer is able to download the digital content using the Download button 778 in FIG. 7F. Billing and payment options can be as before and again, this could work with any purchasing transaction here, digital content is used as an example only.

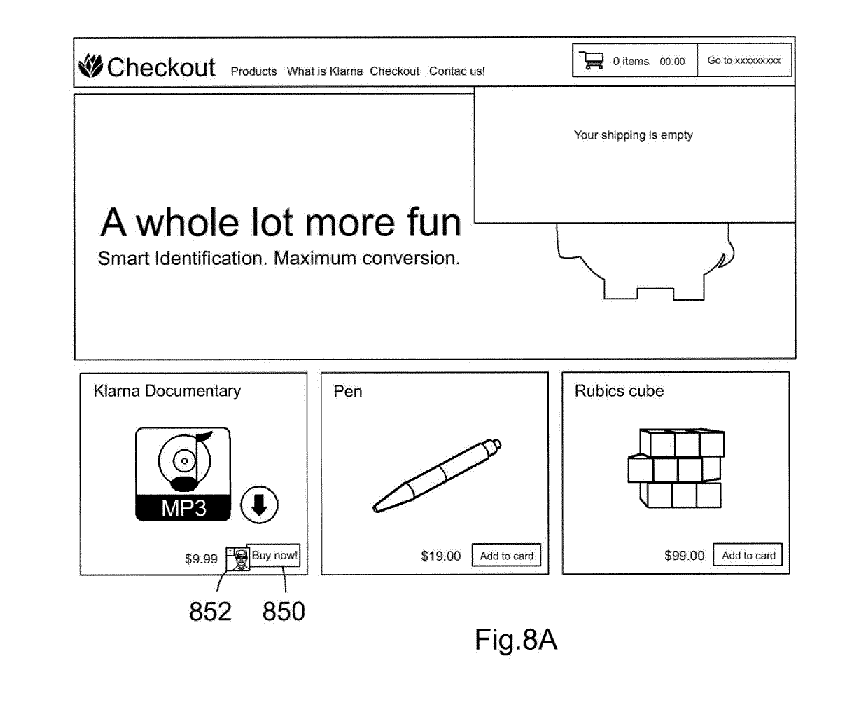

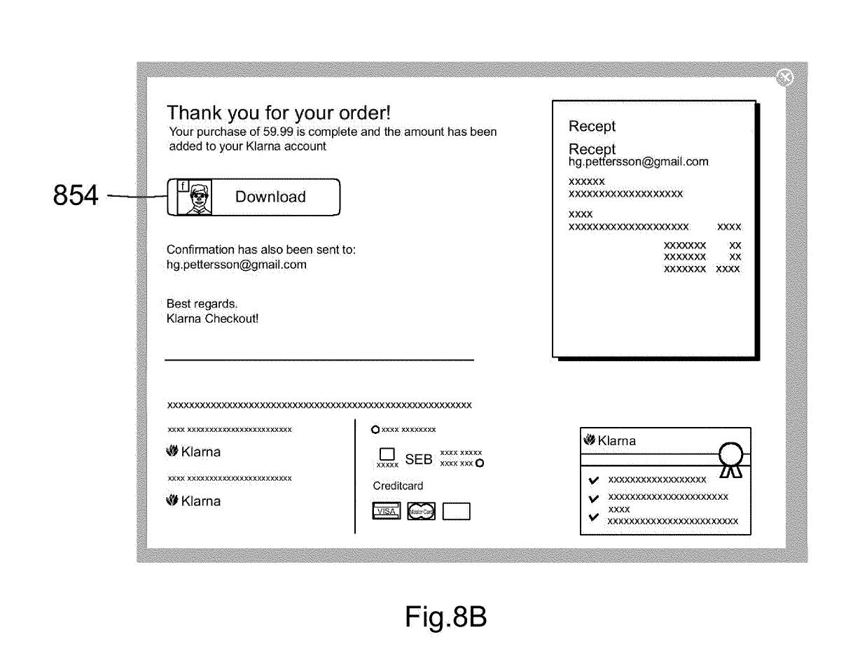

FIGS. 8A and 8B show another example process. In this case, the customer is logged in to a third-party social media website and comes to the merchant's website via that site. When that happens, the customer identity may already be confirmed and the system 214 can check the customer's credit worthiness. If, as shown in FIG. 8A, the customer's credit worthiness is established, the customer can automatically be given the opportunity to “Buy now” (850) with identifying him or herself. As can be seen, the customer's profile picture (852) from, a third-party social media site for example, is pulled in and displayed on the Buy Now button. When the customer selects the Buy Now button, the transaction is confirmed and shipping and billing as previously described can occur. For example, as shown in FIG. 8B, the customer can be given the option to download (854) the digital content or other purchased items.

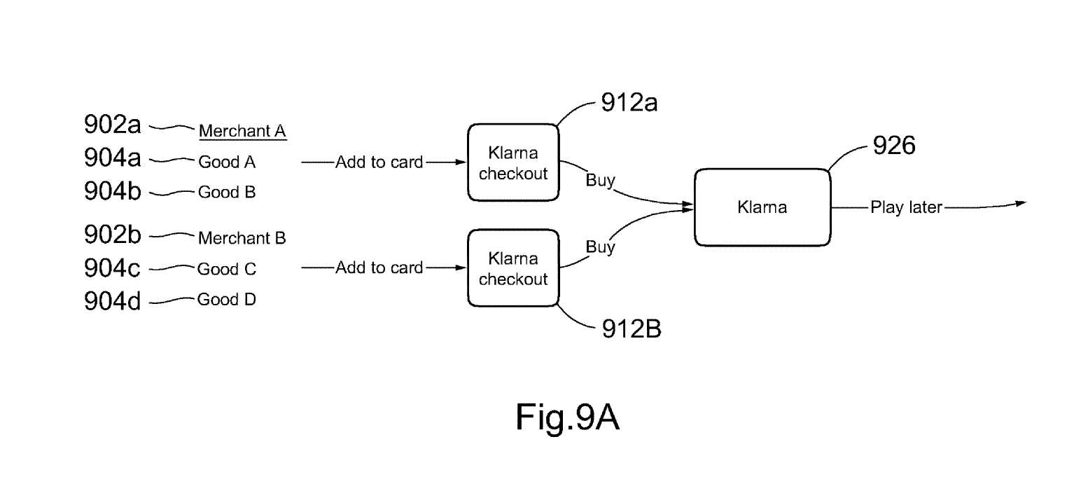

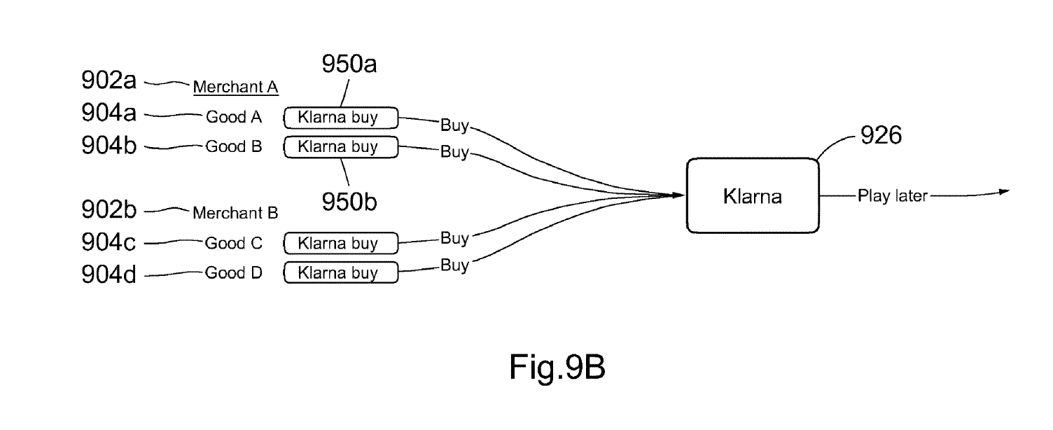

The transaction in FIGS. 8A and 8B can also be used to illustrate two different transaction flows for a customer to purchase goods. These can be illustrated with reference to FIGS. 9A and 9B. Some example distinctions include that in many of the examples above, the customer goes through a checkout that is or at least is embedded in, a merchant site while in FIGS. 9B the transaction flows happen outside the merchants' site. The merchant may then deploy a “Buy” button itself.

In FIG. 9A, the customer (not shown) purchases goods A 904a and B 904b from merchant A 902a, for example. This is done by using the shopping cart/checkout model 912a that is illustrated, for example, with reference to FIG. 4a, etc. As also illustrated, the customer can buy goods C 904c and D 904d from Merchant B 902b, once again using the check to/shopping cart 912b model. Then, at a later stage, the customer receives a single, combined invoice 926 generated by the Online Services System 214, which is then paid.

In FIG. 9B, however, the customer can bypass the checkout/shopping cart entirely. Here the customer can buy Good A 904a from merchant A 902a by selecting the Buy Now button 950a as, for example, in FIGS. 8A and 8B; then the customers can buy Good B, also from Merchant A 902a, once again selecting the Buy Now button 950b without going through the shopping cart process. This is then repeated for example, with Goods C 904c and D 904d, both bought from Merchant B 902b, once again by-passing the shopping cart. All Goods A, B, C and D can automatically be shipped or downloaded at each purchase and later aggregated into a single invoice 926 generated by the Online Services System 214, which is then paid as before. Thus, in the transaction flows shown in FIGS. 9A and 9B, the customer may purchase the same goods (A, B, C and D) from the same two merchants, 902a and 902b, and receives the same combined invoice 926 and settle the invoice 926 in exactly the same manner. The only difference is that, for example in the FIG. 9B example, the customer does not go through the conventional check out process.

### Conclusion

While the subject matter has been described in connection with a series of preferred embodiments, these descriptions are not intended to limit the scope of the subject matter to the particular forms set forth herein. To the contrary, the present descriptions are intended to cover such alternatives, modifications, and equivalents as may be included within the spirit and scope of the subject matter as defined by the appended claims and otherwise appreciate by one of ordinary skill in the art.

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

The method, function and/or system of the invention are in different embodiments realized by means of one or more computer program products comprising code portions configured to perform the method steps or functions described above and/or in the accompanying claims. Embodiments of the claimed invention relate to computer-readable mediums, and computer program products on which are stored non-transitory information for performing stabilization of a sequence of infrared (IR) images.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to utilize the invention and various embodiments with various modifications as are suited to the particular use contemplated.

It is to be understood that aspects of the invention may be implemented by a computing device and/or a computer program stored on a computer-readable medium. The computer-readable medium may comprise a disk, a device, and/or a propagated signal.

It is to be further understood that the invention may assume various alternative orientations and step sequences, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Further, since numerous modifications and changes will readily occur to those skilled in the art, it is not desired to limit the invention to the exact construction and operation shown and described, and accordingly all suitable modifications and equivalents may be regarded as falling within the scope of the invention as defined by any claims that follow.

1. A method for authorizing an online transaction over a data communications network, the method comprising:
receiving a request for a transaction from a user via the network, said transaction request relating to a purchase order;
receiving at least one user identifier;
determining if the user identifier provides sufficient information about an identity of said user to fulfill the transaction;
requesting additional one or more user identifiers until it is determined that there is sufficient information to fulfill the transaction; and
authorizing the transaction if there is sufficient information for transaction fulfillment.

2. The method of claim 1, further comprising:
making a credit assessment based on the one or more user identifiers and the requested online transaction; and
authorizing the requested online transaction based on the credit assessment.

3. The method of claim 1, further comprising:
making a fraud determination based on at least one of the user identifier and the requested online transaction; and
authorizing the requested online transaction based on the fraud determination.

4. The method of claim 1, further comprising:
authorizing the transaction before requesting payment.

5. The method of claim 1, wherein requesting an additional user identifier includes sending a request to the user to provide an additional user identifier.

6. The method of claim 1, wherein requesting an additional user identifier includes retrieving said additional user identifier from a data storage based on a previously received user identifier.

7. The method of claim 6, wherein said data storage is included in a system configured for authorizing said online transaction.

8. The method of claim 6, wherein said data storage is via the network in communication with a system configured for authorizing said online transaction.

9. The method of claim 1, further comprising: requesting an additional user identifier that is inherently unique to a user.

10. The method of claim 1, further comprising: requesting an additional user identifiers that is not derivable from previously retrieved user identifiers.

11. The method of claim 1, further comprising presenting user data to the user for verification by the user, via the network.

12. The method of claim 1, wherein determining that the one or more user identifiers provide sufficient information if the user is deemed to be identified with a known individual, based on said user identifiers and according to a predetermined set of rules.

13. The method of claim 1, wherein the at least one user identifier is at least one of, a zip code, an email address, a physical street address, a mobile phone number, and a land line phone number.

14. The method of claim 1, wherein information about the identity of said user is received from a third-party based on a user identifier.

15. The method of claim 14, wherein the third party is a social media website.

16. The method of claim 1, wherein the sufficient information about the user to fulfill the transaction includes at least one of: a physical shipping address, an email address of the user, a mobile phone number and user equipment information.

17. The method of claim 1, wherein the fulfillment determination includes determining whether sufficient information to complete the transaction exits, including at least one of, information regarding user device information and email address of the user if the user purchase order is for a download.

18. The method of claim 1, wherein the fulfillment determination includes determining whether sufficient information to complete the transaction exits, including at least information for a physical shipping address if the user purchase order is for a shipment of physical goods.

19. The method of claim 2, wherein the credit assessment includes a determination of a maximum credit limit based on the received user identifiers.

20. The method of claim 2, wherein the credit determination includes whether a credit limit has been exceeded.

21. The method of claim 2, wherein the credit assessment includes creating a reservation for credit when the credit assessment is made in response to said transaction request.

22. The method of claim 2, wherein the credit assessment includes a determination of a credit limit made in response to said transaction request, and wherein the credit limit is calculated for each transaction and set to a transaction specific value.

23. The method of claim 2, wherein the credit assessment is based on at least one of: transaction specifics, goods purchased, user details, merchant, order price, payment plan, user income, payment remarks, user payment history, and recent user purchase activity.

24. The method of claim 2,wherein the credit assessment is made including information from a third party.

25. The method of claim 2, further comprising: requesting additional user information, and using the additional user information to determine if there is sufficient information to complete the credit assessment.

26. The method of claim 2, wherein the credit assessment includes requesting user information until enough information has been obtained to identify the user and to determine the credit risk of the user in the requested online transaction dependent on predetermined rules.

27. The method of claim 3, wherein the fraud detection is made according to predetermined rules.

28. The method of claim 2, further comprising:
making a fraud determination based on at least one of, the user identifier, additional user information, and order price and the credit assessment; and
authorizing the transaction dependent on the fraud determination.

29. The method of claim 3, further comprising:
requesting at least one of, one or more additional user identifiers and additional user information, if there is not sufficient information to make a fraud determination dependent on predetermined rules.

30. The method of claim 4, wherein the transaction is authorized before a payment method is selected by the user.

31. The method of claim 4, wherein the transaction is authorized before receiving user payment information.

32. The method of claim 4, wherein the transaction is completed before receiving user payment information.

33. The method of claim 4, wherein the transaction is authorized dependent on a risk assessment according to predetermined rules.

34. A system for authorizing an online transaction over a data communications network, the system comprising:
a server in communication with a merchant system via the data communications network;
wherein the server is configured to:
receive a request for a transaction from a user device of a user via the network, said transaction request relating to a purchase order;
receive at least one user identifier from a user via the data communications network;
determine if the user identifier provides sufficient information about the identity of said user to fulfill the transaction;
request additional one or more user identifiers until it is determined that there is sufficient information to fulfill the transaction; and
authorize the transaction if there is sufficient information for transaction fulfillment.

35. The system of claim 34, wherein the server is further configured to:
make a credit assessment based on the user identifiers and the requested transaction; and
authorize the transaction dependent on the credit assessment.

36. The system of claim 34, wherein the server is further configured to:
make a fraud determination based on at least one of, the user identifier and the requested transaction; and
authorize the transaction dependent on the fraud determination.

37. The system of claim 34, wherein the server is further configured to:
authorize the requested transaction before a request for payment.

38. The system of claim 34, wherein requesting additional one or more user identifiers includes sending a request to the user to provide an additional user identifier.

39. The system of claim 34 further comprising: a data storage in communication with the data communications network,
wherein requesting additional one or more user identifiers includes retrieving said additional user identifier from the data storage dependent on a previously received user identifier.

40. The system of claim 39, wherein said data storage is included in the system configured for authorizing said online transaction.

41. The system of claim 39, wherein said data storage is in communication with the system configured for authorizing said online transaction.

42. The system of claim 34, further comprising: wherein the server is further configured to: request an additional user identifier that is inherently unique to a user.

43. The system of claim 34, wherein the server is further configured to: request an additional user identifier that is not derivable from previously retrieved user identifiers.

44. The system of claim 34, wherein the server is further configured to:
cause display of user data on a user device for verification by the user.

45. The system of claim 34, wherein the server is configured to: determine that the one or more user identifiers provide sufficient information if the user is deemed to be identified with a known individual, based on said user identifiers and according to a predetermined set of rules.

46. The system of claim 34, wherein the at least one user identifier is at least one of, a zip code, an email address, a physical street address, a mobile phone number, and a land line phone number.

47. The system of claim 34, wherein information about the identity of said user is received from a third-party based on a user identifier.

48. The system of claim 34, wherein the third party is a social media website.

49. The system of claim 34, wherein sufficient information about the user to fulfill the transaction includes at least one of: a physical shipping address, an email address of the user, a mobile phone number and user equipment information.

50. The system of claim 34, wherein the fulfillment determination includes the server being further configured to:
determine whether sufficient information to complete the transaction exits, including at least one of, information regarding user device information and email address of the user if the user purchase order is for a download.

51. The system of claim 34, wherein the fulfillment determination includes the server being further configured to: determine whether sufficient information to complete the transaction exits, including at least information for a physical shipping address if the user purchase order is for a shipment of physical goods.

52. The system of claim 35, wherein the credit assessment comprises a determination of a maximum credit limit based on the user identifiers.

53. The system of claim 35, wherein the credit determination includes whether a credit limit has been exceeded.

54. The system of claim 35, wherein the credit assessment includes creating a reservation for credit when the credit assessment is made, in response to said transaction request.

55. The system of claim 35, wherein the credit assessment includes a determination of a credit limit made in response to said transaction request, and wherein the credit limit is calculated for each transaction and set to a transaction specific value.

56. The system of claim 35, wherein the credit assessment is based on at least one of: transaction specifics, goods purchased, user details, merchant, order price, payment plan, user income, payment remarks, user payment history, and recent user purchase activity.

57. The system of claim 35, wherein the credit assessment is made including information received from a third party.

58. The system of claim 35, wherein the server is further configured to:
determine if there is sufficient information to complete the credit assessment and if not, request additional user information.

59. The system of claim 35, wherein the credit assessment includes requesting user information until enough information has been obtained to identify the user and to determine the credit risk of the specific user in the specific transaction dependent on predetermined rules.

60. The system of claim 36, wherein fraud detection is made according to predetermined rules.

61. The system of claim 35, wherein the server is further configured to:
make a fraud determination based on at least one of, the user identifier, additional user information, the order price and the credit assessment; and
authorize the requested transaction dependent on the fraud determination.

62. The system of claim 36, wherein the server is further configured to:
request at least one of, one or more additional user identifiers and additional user information, if there is not sufficient information to make a fraud determination.

63. The system of claim 37, wherein the transaction is authorized before a payment method is selected.

64. The system of claim 37, wherein the transaction is authorized before receiving user payment information.

65. The system of claim 37, wherein the transaction is completed before receiving user payment information.

66. The system of claim 37, wherein the transaction is authorized dependent on a risk assessment according to predetermined rules.

67. A method for authorizing an online transaction over a network, the method comprising:
via a server in communication with at least one data storage and the network,
receiving a request for a transaction from at least one user via the network, said transaction request relating to a purchase order;
receiving at least one user identifier corresponding to the at least one user requesting the transaction via the network;
determining if the received user identifier provides sufficient information about an identity of said user to fulfill the transaction;
if the determination is negative,
requesting additional one or more user identifiers corresponding to the at least one user;
receiving the additional one or more user identifiers corresponding to the at least one user; and
determining if the received additional one or more of the requested user identifiers provides sufficient information about an identity of said user to fulfill the transaction;
authorizing the transaction if there is sufficient information for transaction fulfillment; and
requesting payment from the user via the network, after authorizing the transaction.
